(19) United States
(12) Patent Application Publication
(10) Pub. No.: US 2024/0199904 A1
(43) Pub. Date: Jun. 20, 2024

(54) BIO-INSPIRED ELECTROCHROMIC PIXELS AND SYSTEMS INCORPORATING SAME

(71) Applicant: Northeastern University, Boston, MA (US)

(72) Inventors: Patrick A. Sullivan, Cambridge, MA (US); Daniel J. Wilson, Medford, MA (US); Matthew Vallon, Boston, MA (US); Duncan Q. Bower, Winchester, MA (US); Leila F. Deravi, Cambridge, MA (US)

(21) Appl. No.: 18/330,101

(22) Filed: Jun. 6, 2023

Related U.S. Application Data
(60) Provisional application No. 63/399,357, filed on Aug. 19, 2022.

(51) Int. Cl. C09D 11/52; C09D 11/322; C09D 11/50; G02F 1/155; G02F 1/157; G02F 1/161; G02F 1/163

(52) U.S. Cl. CPC C09D 11/52; C09D 11/322; C09D 11/50; G02F 1/155; G02F 1/157; G02F 1/161; G02F 1/163

(57) ABSTRACT

In some embodiments, an electrochromic pixel includes a first electrode having a first electrical lead facilitating a power supply connection and a second electrode having a second electrical lead facilitating the power supply connection. The electrochromic pixel further includes an electrolyte electrically connecting the first and second electrodes, and xanthommatin (Xa), or a derivative or precursor thereof, such that an electrical potential applied between the first electrode and the second electrode is configured to cause an oxidation or reduction of the xanthommatin (Xa), or a derivative or precursor thereof, thereby providing a change in reflected visible color of the Xa, or a derivative or precursor thereof.

### RELATED APPLICATION

This application claims the benefit of U.S. Provisional Application No. 63/399,357, filed on Aug. 19, 2022. The entire teachings of the above application are incorporated herein by reference.

### GOVERNMENT SUPPORT

This invention was made with government support under Grant Number N00014-19-1-2137 and N00014-22-1-2053 from the Office of Naval Research, and W911QY-19-9-0011 awarded by the U.S. Army Combat Capabilities Development Command Soldier Center. The government has certain rights in the invention.

### BACKGROUND

Adaptive coloration, or camouflage, in nature is often used as a strategy for organisms to visually blend in with or stand out from their surroundings for defensive, communicative, or predatory purposes. While the mechanisms regulating camouflage in nature are species-dependent, in most cases they can be generalized as mechanically, biochemically, and/or electrically activated events that alter visible colors. However, these generalizations become far more complicated when considering full system integration, which requires the inclusion of controls that also distribute signals (e.g., mechanical, biochemical, and/or electrical) across large surface areas for global color changes. Cephalopods (cuttlefish, octopus, and squid) are an example of a living system which can achieve this function by controlling nodes of densely populated dermal pigmented organs called chromatophores in less than a second to obscure or reveal light. As such, they represent a powerful model for dynamic color-changing systems.

In nature, the redox-sensitive biochrome xanthommatin (Xa) is present as a physiological indicator with red (reduced) or yellow (oxidized) colors associated with different behavioral or developmental stages in some species.

There is a need to harness these natural features in materials applications, for example, in bio-inspired design solutions for creating color-changing sensors and displays.

SUMMARY

In some embodiments, an electrochromic pixel includes a first electrode having a first electrical lead facilitating a power supply connection and a second electrode having a second electrical lead facilitating the power supply connection. The electrochromic pixel further includes an electrolyte electrically connecting the first and second electrodes, and xanthommatin (Xa), or a derivative or precursor thereof, such that an electrical potential applied between the first electrode and the second electrode is configured to cause oxidation or reduction of the Xa, or a derivative or precursor thereof, thereby providing a change in reflected visible color of the Xa, or a derivative or precursor thereof.

In some embodiments, the electrolyte is a liquid electrolyte. In some embodiments, the liquid electrolyte is formed of propylene carbonate, 1-butyl-3-methylimidazolium tetrafluoroborate, and hydroquinone.

In some embodiments, the electrolyte is a solid electrolyte.

In some embodiments, the electrolyte is a gel electrolyte.

In some embodiments, one or more of the first electrode and second electrode are conductive electrodes made from indium-doped tin oxide (ITO) coated polyethylene terephthalate (PET) plastic.

In some embodiments, the first electrode is a lower electrode, the second electrode is an upper electrode. The electrochromic pixel further includes a spacer configured to contain the electrolyte and provide a gap between the first electrode and second electrode.

In some embodiments, the first electrode and second electrode are uncoated PET electrodes, the spacer is a non-conductive laser-cut PET spacer, the upper electrode is coated in poly(3,4-ethylenedioxthionphene) and polystyrene sulfonate (PETDOT:PSS).

In some embodiments, the first electrode is an inner electrode, and the second electrode is an outer electrode connected to a second electrical lead. The outer electrode is separated from the inner electrode by a gap. The electrochromic pixel further includes a gasket affixed to a substrate housing the inner electrode and the outer electrode and filled with an electrically conductive electrolyte.

In some embodiments, applying a positive or negative electrical potential across the first electrical lead and second electrical lead of the first electrode and second electrode, respectively, causes an oxidation or reduction of the Xanthommatin (Xa), or a derivative or precursor thereof, thereby providing a change in reflected visible color of the Xa, or a derivative or precursor thereof.

In some embodiments, one or more reflectance-based color sensors can be oriented to sense color from outside of the system. A display can include one or more electrochromic pixels described above. A microcontroller and associated electronics operatively coupled to the one or more reflectance-based color sensors and the one or more electrochromic pixels, configured to receive information representing a color and/or light intensity detected by the one or more reflectance-based color sensors and determine a signal to send to the electrochromic pixels providing information to control at least one of color and light intensity, resulting in the electrochromic pixels presenting at least one of the color and light intensity.

In some embodiments of the present disclosure, a system includes one or more reflectance-based color sensors oriented to sense color from outside of the system. The system can include one or more electrochromic pixels. The system can further include a microcontroller and associated electronics. The microcontroller and associated electronics are operatively coupled to the one or more reflectance-based color sensors and the one or more electrochromic pixels, and are configured to receive information representing at least one of a color and light intensity detected by the one or more reflectance-based color sensors, and determine a signal to send to the electrochromic pixels providing information to control at least one of color and light intensity. The signal results in the electrochromic pixels presenting at least one of the color and light intensity.

In some embodiments, the system further includes one or more LEDs positioned to provide lighting for the one or more electrochromic pixels. The microcontroller and associated electronics can be configured to determine the signal to send to the electrochromic pixels providing the information to control color, such that the signal controls a color of the electrochromic pixels. The microcontroller and associated electronics can be configured to determine a second signal to send to the one or more LEDs providing information to control light intensity, such that the second signal controls light intensity of the one or more LEDs.

In some embodiments, the system further includes a battery operatively coupled to the microprocessor and associated electronics and one or more LEDs.

In some embodiments, the system further includes a housing. The one or more reflectance-based color sensors, one or more electrochromic pixels, and microprocessor can be within the housing, such that the one or more reflectance-based color sensors are on at least one face of the housing and oriented to sense color from outside of the housing, and the one or more electrochromic pixels are oriented to project the color outside of the housing.

In some embodiments, applying a positive or negative electrical potential to each of the one or more electrochromic pixels causes an oxidation or reduction of the Xanthommatin (Xa), or a derivative or precursor thereof, thereby providing a change in reflected visible color of the Xa, or a derivative or precursor thereof.

In some embodiments, a method of providing an electrochromic pixel includes providing a power supply connection to a first electrode via a first electrical lead and to a second electrode via a second electrical lead. The method further includes electrically connecting the first and second electrodes via an electrolyte. Xanthommatin (Xa), or a derivative or precursor thereof, such that an electrical potential applied between the first electrode and the second electrode is configured to cause oxidation or reduction of the Xa, or a derivative or precursor thereof, thereby providing a change in reflected visible color of the Xa, or a derivative or precursor thereof.

In some embodiments, the first and second electrodes are conductive electrodes made from indium-doped tin oxide (ITO) coated polyethylene terephthalate (PET) plastic.

In some embodiments, the first electrode is a lower electrode, the second electrode is an upper electrode. The method can further include providing a spacer between the first electrode and second electrode configured to create a gap between the first electrode and the second electrode that contains an electrolyte.

In some embodiments, the first electrode is an inner electrode, and the second electrode is an outer electrode. The outer electrode is separated from the inner electrode by a gap. The method includes affixing a gasket to a substrate housing the inner electrode and the outer electrode, such that the gap is within the gasket and filled with an electrically conductive electrolyte.

In some embodiments, the electrode is an uncoated PET electrode, the spacer is a non-conductive laser-cut PET spacer, and the upper electrode is coated in poly(3,4-ethylenedioxthionphene) and polystyrene sulfonate (PETDOT:PSS).

In some embodiments, applying a positive or negative electrical potential to each of the one or more electrochromic pixels causes oxidation or reduction of the Xanthommatin (Xa), or a derivative or precursor thereof, thereby providing a change in reflected visible color of the Xa, or a derivative or precursor thereof.

In some embodiments, a method includes providing one or more reflectance-based color sensors oriented to sense color from outside of the system, and one or more electrochromic pixels. The method can further include, by a microcontroller having associated electronics coupled to the one or more reflectance-based color sensors and the one or more electrochromic pixels, receiving information representing at least one of a color and light intensity detected by the one or more reflectance-based color sensors, and determining a signal to send to the electrochromic pixels providing information to control at least one of color and light intensity, resulting in the electrochromic pixels presenting at least one of the color and light intensity.

In some embodiments, the method further includes, by the microcontroller, determining the signal to send to the electrochromic pixels providing the information to control color, such that the signal controls a color of the electrochromic pixels, and determining a second signal to send to one or more LEDs, the one or more LEDs positioned to provide lighting for the one or more electrochromic pixels, providing information to control light intensity, such that the second signal controls light intensity of the one or more LEDs.

In some embodiments, the microprocessor and associated electronics and one or more LEDs are operatively coupled to a battery.

In some embodiments, the one or more reflectance-based color sensors, one or more electrochromic pixels, and microprocessor are within a housing, such that the one or more reflectance-based color sensors are on at least one face of the housing and oriented to sense color from outside of the housing, and the one or more electrochromic pixels are oriented to project the color outside of the housing.

In some embodiments, the one or more electrochromic pixels are conductive electrodes made from indium-doped tin oxide (ITO) coated polyethylene terephthalate (PET) plastic.

In some embodiments, the electrode can be an uncoated PET electrode, the spacer is a non-conductive laser-cut PET spacer, and the upper electrode is coated in poly(3,4-ethylenedioxthionphene) and polystyrene sulfonate (PETDOT:PSS). In some embodiments, applying a positive or negative electrical potential to each of the one or more electrochromic pixels causes an oxidation or reduction of the Xanthommatin (Xa), or a derivative or precursor thereof, thereby providing a change in reflected visible color of the Xa, or a derivative or precursor thereof.

In some embodiments, a method of manufacturing an electrochromic pixel includes formulating an ink comprising dissolved Xa and an electrically conductive ink. The method includes filtering the ink through a one-micron filter or about a one-micron filter, resulting in a filtered ink. The method further includes printing an electrochromic pixel pattern on at least one sheet of substrate, the electrochromic pixel pattern including two electrodes separated by a gap, each electrode including a lead facilitating a power supply connection. In some embodiments, the method includes sealing an outer border of the electrochromic pixel pattern with a polydimethylsiloxane (PDMS) gasket. In some embodiments, the method further includes applying a curable glue to the PDMS gasket, the glue providing a seal that prevents leakage of a liquid electrolyte housed within the electrochromic pixel pattern.

In some embodiments, formulating the ink further includes dissolving xanthommatin (Xa), or a derivative or precursor thereof, in a buffer and mixing the dissolved Xa with an electrically conductive ink.

In some embodiments, the filter is polytetrafluorethylene syringe filter.

In some embodiments, the printing employs a piezoelectric inkjet printer.

In some embodiments, the substrate is polyethylene terephthalate (PET).

In some embodiments, the method further includes sealing an outer border of the electrochromic pixel pattern with an inert polydimethylsiloxane (PDMS) gasket.

In some embodiments, the liquid electrolyte is formed of propylene carbonate, 1-butyl-3-methylimidazolium tetrafluoroborate, and hydroquinone.

In some embodiments, the buffer is a 2-(N-morpholino)ethanesulfonic acid) (MES) buffer.

In some embodiments, the polytetrafluorethylene syringe filter is a 1-μm polytetrafluorethylene syringe filter.

In some embodiments, the method further includes loading the filtered ink into a chamber of a print cartridge configured to be employed with the piezoelectric inkjet printer. In some embodiments, the gap between each electrode is about 1 mm.

In some embodiments, the method includes printing the electrochromic pixel patterns occurs at about 22° C.

In some embodiments, between 1-5 nozzles are employed by the piezoelectric inkjet printer with a 33-kHz jetting frequency at 39 V.

In some embodiments, a system for providing an electrochromic pixel includes an ink formulated by comprising dissolved Xa and an electrically conductive ink that is filtered through a one-micron or a about one-micron filter. The system further includes at least one sheet of polyethylene terephthalate (PET) having an electrochromic pattern printed thereon using a piezoelectric inkjet printer. The electrochromic pixel pattern includes the two electrodes separated by a gap, where each electrode includes a lead facilitating a power supply connection.

In some embodiments, the system includes a polydimethylsiloxane (PDMS) gasket sealing an outer border of the electrochromic pixel pattern.

In some embodiments, the system includes a curable glue applied to the PDMS gasket, the curable glue providing a seal that prevents leakage of a liquid electrolyte housed within the electrochromic pixel pattern.

In some embodiments, the liquid electrolyte is formed of propylene carbonate, 1-butyl-3-methylimidazolium tetrafluoroborate, and hydroquinone.

In some embodiments, the buffer is a 2-(N-morpholino)ethanesulfonic acid) (MES) buffer.

In some embodiments, the polytetrafluorethylene syringe filter is a 1-μm polytetrafluorethylene syringe filter.

In some embodiments, the filtered ink is loaded into a chamber of a print cartridge configured to be employed with the piezoelectric inkjet printer.

In some embodiments, the gap between each electrode is 1 mm.

In some embodiments, the system includes printing the electrochromic pixel patterns occurs at 22° C.

In some embodiments, the system includes a plurality of nozzles employed by the piezoelectric inkjet printer with a 33-kHz jetting frequency at 39 V.

In some embodiments, an ink for an electrochromic pixel, includes xanthommatin (Xa), or a derivative or precursor thereof; and an electrically conductive ink, wherein the Xa, or a derivative or precursor thereof, is in non-aggregated form.

In some embodiments, the ink further includes a buffer.

In some embodiments, the ink has a concentration of Xa, or a derivative or precursor thereof, from greater than 0 to 3 mg mL⁻¹.

In some embodiments, the Xa, or a derivative or precursor thereof, is in solution.

In some embodiments, the ink is aqueous.

In some embodiments, the ink has a viscosity ranging from 8-40 mPas·s.

In some embodiments, the ink has a surface tension of about 40 mN m⁻¹.

In some embodiments, the Xa, or a derivative or precursor thereof, is either Xa, dihyroxanthommatin, or a combination thereof.

In some aspects, the composition further comprises one or more (e.g., one, two, three, four, five, etc.) additional colorants. Colorants can be used alone or in admixture to impart color(s) to a composition, such as a composition described herein. Colorants include metal oxides and other particulate pigments, and also soluble absorbers, such as dyes. In some aspects, the one or more additional colorants comprise a purple colorant, blue colorant, green colorant, yellow colorant, red colorant, black colorant, or white colorant. In some aspects, the one or more additional colorants are selected from a purple colorant, blue colorant, green colorant, yellow colorant, red colorant, black colorant, or white colorant.

In some aspects, the one or more additional colorants are or comprise a soluble dye. In some aspects, the soluble dye is selected from erioglaucine (acid blue 9) or disodium 6-hydroxy-5-[(2-methoxy-5-methyl-4-sulfophenyl)azo]-2-naphthalenesulfonate (Allura Red/Red 40).

In some aspects, the one or more additional colorants are or comprise a pigment. In some aspects, the pigment is selected from titanium dioxide, red iron oxide, yellow iron oxide, carbon black, or Prussian Blue. In some aspects, the pigment is titanium dioxide, red iron oxide, yellow iron oxide, carbon black, or ultramarine blue. For paints, such as those described herein, titanium dioxide is advantageously provided as particles having a particle size of less than about 1 micron, red and yellow iron oxides are advantageously provided as nanopowders or micron-scale particles, carbon black is advantageously provided as particles having a particle size of less than about 100 nm or aggregates, and Prussian Blue is advantageously provided as a colloidal dispersion.

Common colorants are widely available, and include, but are not limited to, colorants colored purple (e.g., ultramarine violet (Al); han purple (Cu); cobalt violet; purple of cassius (Au), etc.), blue (e.g., cobalt blue; Egyptian blue (Cu); Prussian blue (Fe); etc.), green (e.g., cadmium green; chrome green (Cr); Scheele's green (Cu); etc.), yellow (e.g., orpiment (As); primrose yellow (Bi); naples yellow (Pb); etc.), orange (e.g., bismuth vanadate orange; cadmium pigments; etc.), red (e.g., red ochre (Fe); cinnabar (Hg); burnt sienna (Fe); carmine (Al); etc.), and white (e.g., antimony white; lithopone (Ba); cremnitz white (Pb); etc.). In some embodiments, the colorant is colored blue (e.g., ultramarine blue).

“About” means within an acceptable error range for the particular value, as

determined by one of ordinary skill in the art. Typically, an acceptable error range for a particular value depends, at least in part, on how the value is measured or determined, e.g., the limitations of the measurement system. For example, “about” can mean within an acceptable standard deviation, per the practice in the art. Alternatively, “about” can mean a range of ±20%, e.g., ±10%, ±5% or ±1% of a given value. It is to be understood that the term “about” can precede any particular value specified herein, except for particular values used in the Exemplification.

“Phenoxazone,” as used herein, refers to a compound having the following molecular skeleton:

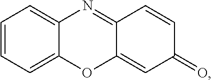 [SMILES: O=c1ccc2nc3ccccc3oc-2c1]

or a salt thereof. Examples of phenoxazones include ommatins, such as xanthommatin. In some aspects, the phenoxazone or phenoxazine is a phenoxazone, e.g., an ommatin.

“Phenoxazine,” as used herein, refers to a compound having the following molecular skeleton:

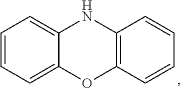 [SMILES: c1ccc2c(c1)Nc1ccccc1O2]

or a salt thereof. Examples of phenoxazines include ommins, such as ommin A. In some aspects, the phenoxazone or phenoxazine is a phenoxazine, e.g., an ommin.

In some aspects, the phenoxazone or phenoxazine is an ommochrome, e.g., an ommatin, an ommin. Ommochromes are pigments found in invertebrates, particularly crustaceans, and insects, and are thought to be synthesized in vivo from 3-hydroxykynurenine, either via uncyclized xanthommatin or by condensation of 3-hydroxykynurenine and xanthurenic acid. It is hypothesized that cyclization of uncyclized xanthommatin produces ommatins, such as xanthommatin, dihydroxanthommatin, decarboxylated xanthommatin, ommatin D, and rhodommatin, as well as ommins, such as ommin A. Ommatins are typically phenoxazones, such as pyrido-phenoxazones, while ommins are typically phenoxazines, such as phenoxazine-phenothiazines.

As used herein, “xanthommatin” refers to 11-(3-amino-3-carboxypropanoyl)-1,5-dioxo-4H-pyrido[3,2-a]phenoxazine-3-carboxylic acid. Xanthommatin and various of its precursors and derivatives can be extracted from cephalopods (e.g., squid Doryteuthis pealeii chromatophores) and other natural sources, such as the eyes, integumentary system, organs, and eggs of arthropods. Xanthommatin and its precursors and derivatives can also be synthesized using methods described herein and/or known in the art.

As described herein, the reversible change in oxidation state, with respect to xanthommatin, refers to the interchange of xanthommatin and dihydroxanthommatin:

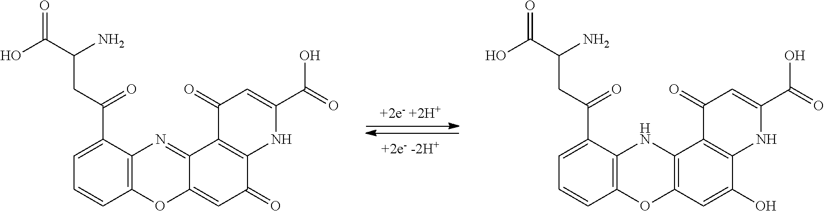 [SMILES: NC(CC(=O)c1cccc2oc3cc(=O)c4[nH]c(C(=O)O)cc(=O)c4c-3nc12)C(=O)O ; NC(CC(=O)c1cccc2c1Nc1c(cc(O)c3[nH]c(C(=O)O)cc(=O)c13)O2)C(=O)O]

As used herein, “xanthommatin, or a derivative or precursor thereof” includes synthetic precursors, such as biosynthetic precursors, of xanthommatin, as well as derivatives, such as metabolites, of xanthommatin, or a salt thereof. Precursors (e.g., biosynthetic precursors) of xanthommatin include, for example, 3-hydroxykynurenine, xanthurenic acid, and uncyclized xanthommatin. Derivatives (e.g., metabolites) of xanthommatin include, for example, dihydroxanthommatin, decarboxylated xanthommatin, ommatin C, ommatin D, rhodommatin, hydroxanthommatin, tinctoriommatin, iso-tinctoriommatin, alpha-hydroxy xanthommatin dimethyl ester, oranyeommatin methyl ester, elymniommatin, iso-elymniommatin, oranyeommatin, and a-hydroxy xanthommatin methyl ester. In some aspects, the xanthommatin, or a derivative or precursor thereof, comprises xanthommatin, dihydroxanthommatin, or xanthommatin and dihydroxanthommatin. In some aspects, the xanthommatin, or a derivative or precursor thereof, is xanthommatin, dihydroxanthommatin, or xanthommatin and dihydroxanthommatin. In some aspects, the xanthommatin, or a derivative or precursor thereof, is in non-aggregated form, e.g., is in solution or dissolved.

Salts of the compounds described herein include salts derived from suitable inorganic and organic acids, and suitable inorganic and organic bases.

Examples of acid addition salts are salts of an amino group formed with inorganic acids such as hydrochloric acid, hydrobromic acid, phosphoric acid, sulfuric acid and perchloric acid, or with organic acids such as acetic acid, trifluoroacetic acid, oxalic acid, maleic acid, tartaric acid, citric acid, succinic acid or malonic acid or by using other methods used in the art, such as ion exchange. Other pharmaceutically acceptable acid addition salts include adipate, alginate, ascorbate, aspartate, benzenesulfonate, benzoate, bisulfate, borate, butyrate, camphorate, camphorsulfonate, cinnamate, citrate, cyclopentanepropionate, digluconate, dodecylsulfate, ethanesulfonate, formate, fumarate, glucoheptonate, glycerophosphate, gluconate, glutarate, glycolate, hemisulfate, heptanoate, hexanoate, hydroiodide, hydroxybenzoate, 2-hydroxy-ethanesulfonate, hydroxymaleate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 2-phenoxybenzoate, phenylacetate, 3-phenylpropionate, phosphate, pivalate, propionate, pyruvate, salicylate, stearate, succinate, sulfate, tartrate, thiocyanate, p-toluenesulfonate, undecanoate, valerate salts, and the like.

Salts derived from appropriate bases include salts derived from inorganic bases, such as alkali metal, alkaline earth metal, and ammonium bases, and salts derived from aliphatic, alicyclic or aromatic organic amines, such as methylamine, trimethylamine and picoline, or N+((C1-C4)alkyl)4 salts. Representative alkali or alkaline earth metal salts include sodium, lithium, potassium, calcium, magnesium, barium and the like. Further salts include, when appropriate, nontoxic ammonium, quaternary ammonium, and amine cations formed using counterions such as halide, hydroxide, carboxyl, sulfate, phosphate, nitrate, lower alkyl sulfonate and aryl sulfonate.

Salts of 11-(3-amino-3-carboxypropanoyl)-1,5-dioxo-4H-pyrido[3,2-a]phenoxazine-3-carboxylic acid, or a derivative or precursor thereof, can be prepared from a parent compound that contains a basic or acidic moiety by conventional chemical methods. Generally, such salts can be prepared by reacting the free acid or free base form of the parent compounds with a stoichiometric amount of an appropriate base or acid, respectively, in a suitable medium, such as water, an organic solvent, or a mixture of water and an organic solvent. Typically, nonaqueous media, such as ether, ethyl acetate, ethanol, isopropanol, or acetonitrile, are preferred.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram illustrating an example embodiment of a schematic of multilayered device design of the portable, self-contained system.

FIG. 2A is a breakaway diagram illustrating components of the electrochromic device.

FIG. 2B is a diagram illustrating that devices assembled by lamination contain independently controlled xanthommatin-based electrochromic pixels that are connected to tab connectors.

FIG. 2C is a diagram illustrating example embodiments of polarity of the potential applied to an electrochromic pixel changing direction.

FIG. 3A-B is a schematic of an example embodiment of the system of the present disclosure.

FIG. 3C is a photograph illustrating a top view of an example integrated prototype of the system.

FIG. 3D is a photograph illustrating a side view of an example integrated prototype of the system.

FIG. 4A is a diagram illustrating a pattern placed on paper for sensing by the color sensors.

FIGS. 4B-D are photographs illustrating a setup to evaluate the system including observing rapid color changes in the electrochromic pixels on the top layer of the devices in response to color changes measured by the sensors at the bottom of the device.

FIG. 5 is a diagram illustrating one example of a wireless implementation.

FIG. 6A is a block diagram illustrating an example embodiment of the present disclosure.

FIG. 6B is a block diagram illustrating an example embodiment of the present disclosure.

FIG. 7A is a graph illustrating calculated Z-values corresponding to the PEDOT-Xa ink blends.

FIG. 7B is an image of 1-cm² patterns of the PEDOT-Xa ink blends ([Xa]=greater than 0 to 3 mg mL⁻¹) as a function of print layer count.

FIG. 7C is a graph illustrating thickness of the 1-cm² patterns depicted in FIG. 7B.

FIG. 7D is a graph illustrating conductivity of the 1-, 3-, 5-, 7- and 10- layer patterns depicted in FIG. 7B.

FIG. 8A(i) is a diagram illustrating an example embodiment of a schematic of device assembly of a device with a potential of 1.5V. Scale bars correspond to 1 cm.

FIG. 8A(ii)is a diagram illustrating an example embodiment of schematics of the device of FIG. 8A(i) and an image of the device in oxidized state. Scale bars correspond to 1 cm.

FIG. 8A(iii) is a diagram illustrating an example embodiment of schematics of the device of FIG. 8A(i) and an image of the device in reduced state. Scale bars correspond to 1 cm.

FIG. 8B is a graph of a normalized green RGB value tracked over 10 cycles of device function alternating between +1.5 V and −1.5 V every 150 seconds.

FIG. 8C is a graph of chronoamperometry results showing the current across the device during cycling as described in relation to FIG. 8B.

FIG. 8D is a graph illustrating color analysis of the first and last 5 cycles of ECPs function over a 500-cycle test period.

FIG. 9A is a diagram and images illustrating a schematic of a 4-pixel device with an on off microcontroller program.

FIG. 9B is a diagram and images illustrating a schematic of a 4-pixel device with a chase microcontroller program.

FIG. 10Ai-Aii is a picture illustrating a ECP printed at 100%, 50%, and 25% scale of the initial pixel size in the (10Ai) oxidized and (10Aii) reduced states.

FIG. 10B is a graph illustrating green RGB value of a 50% scaled pixel.

FIG. 10C is a graph illustrating green RGB value of a 25% scaled pixel.

FIG. 11 is a schematic illustrating the electrochromic pixel (ECP) with a diagram of the cycle experiment.

FIG. 12 is a graph illustrating an RGB analysis of the first 15 cycles of a 7-layer printed PEDOT-Xa ([Xa=2 mg mL⁻¹) ECP.

FIG. 13 is a graph of conductivity analysis in a variety of curing conditions post print for 10-layer printed PEDOT:PSS ink straight from vendor, where the error bars represent standard deviation of n=3 replicates per condition.

FIG. 14 is a graph illustrating an effect of Xa concentration on conductivity in a 7-layer pattern that compares the conductivity of 0, 1, 2 and 3 mg mL⁻¹ Xa ink blends when printed in a 7-layer pattern, where the error bars represent standard deviation of n=3 replicates per condition.

FIG. 15Ai-Aii is a graph illustrating an analysis of change in RGB channel values across a 7-layer 2 mg mL⁻¹ Xa ECP over 10 cycles for the inner electrode in both (15Ai) raw values representing the maximum and minimum values for each color channel with the associated change in color between the reduced and oxidized states and (15Aii) change in maximum and minimum values for the oxidized and reduced states of each electrode, where the error bars represent standard deviation of n=3 replicates per condition.

FIG. 15Bi-Bii is a graph illustrating an analysis of change in RGB channel values across a 7-layer 2 mg mL⁻¹ Xa ECP over 10 cycles for the outer electrode in both (15Bi) raw values representing the maximum and minimum values for each color channel with the associated change in color between the reduced and oxidized states and (15Bii) change in maximum and minimum values for the oxidized and reduced states of each electrode, where the error bars represent standard deviation of n=3 replicates per condition.

FIGS. 16A-D are graphs illustrating Xa concentration effect on accessible color space of the 7-layer ECP. Green channel color analysis of the Xa ink blends (A) 0, (B) 1, (C) 2 and (D) 3 mg mL⁻¹ with associated photos of the devices in oxidized and reduced states, where error bars represent standard deviation of n=3 replicates per condition with scale bar corresponding to 1 cm.

FIG. 17 is a graph illustrating an analysis of the green channel of the 5-layer 2 mg mL⁻¹ Xa ECP in oxidized and reduced states, where error bars represent standard deviation of n=3 replicates per condition and the scale bar corresponds to 1 cm.

FIG. 18A is a graph illustrating an overlay of the green channel color analysis and the chronoamperometry data collected for 10-layer 0 mg mL⁻¹ Xa ECP, where error bars represent standard deviation of n=3 replicates per condition.

FIG. 18B is a graph illustrating an overlay of the green channel color analysis and the chronoamperometry data collected for 10-layer 2 mg mL⁻¹ Xa ECP, where error bars represent standard deviation of n=3 replicates per condition.

FIG. 19A is a graph illustrating a characterization of control pattern, illustrating a normalized green channel value for the 10-layer device for 0 mg mL⁻¹ Xa ECP tracked over 10 cycles device function alternating between +1.5 V and −1.5 V every 150 seconds, where error bars represent standard deviation of n=3 replicates per condition and the scale bar corresponds to 1 cm.

FIG. 19B is a graph illustrating a characterization of control pattern, illustrating chronoamperometry results showing the current across the device during its cycling as described in FIG. 19A, where error bars represent standard deviation of n=3 replicates per condition and the scale bar corresponds to 1 cm.

FIG. 19C is a photograph of the oxidation state in a physical device.

FIG. 20A is a graph illustrating a characterization of the 10-layer 2 mg mL⁻¹ Xa ECP over 500 cycles showing chronoamperometry data for the 500 cycles, with the scale bar corresponding to 1 cm.

FIG. 20B are photographs of the 3^{rd} cycle and 497^{th} cycle, with the scale bar corresponding to 1 cm.

FIG. 20C is a graph illustrating chronoamperometry data (current) for the first 5 cycles and the last 5 cycles.

FIG. 21A is a graph illustrating an overlay of the green channel color analysis and the chronoamperometry data collected for the miniaturized devices for a 10-layer 2 mg mL⁻¹ Xa 50% scale device, where error bars represent standard deviation of n=3 replicates per condition.

FIG. 21B is a graph illustrating an overlay of the green channel color analysis and the chronoamperometry data collected for the miniaturized devices for a 10-layer 2 mg mL⁻¹ Xa 25% scale device, where error bars represent standard deviation of n=3 replicates per condition.

FIG. 22A is a photograph of a 10-layer 2 mg mL⁻¹ Xa device color cycling at 50× speed with a scale bar corresponding to 1 cm.

FIG. 22B is a photograph of a 10-layer 0 mg mL⁻¹ Xa device color cycling at 50× speed with a scale bar corresponding to 1 cm.

FIG. 23A is a photograph of a 10-layer 2 mg mL⁻¹ Xa 4-pixel device color running the On/Off program at 100× speed with a scale bar corresponding to 1 cm.

FIG. 23B is a photograph of a 10-layer 2 mg mL⁻¹ Xa 4-pixel device color running the Chase program at 100× speed with a scale bar corresponding to 1 cm.

FIG. 24A is a photograph of a 10-layer 2 mg mL⁻¹ Xa 50% scale device color cycling at 50× speed with a scale bar corresponding to 1 cm.

FIG. 24B is a photograph of a 10-layer 2 mg mL⁻¹ Xa 25% scale device color cycling at 50× speed with a scale bar corresponding to 1 cm.

FIG. 25 illustrates a computer network or similar digital processing environment in which embodiments of the present invention may be implemented.

FIG. 26 is a diagram of an example internal structure of a computer (e.g., client processor/device or server computers) in the computer system of FIG. 25.

### DETAILED DESCRIPTION

A description of example embodiments follows.

In some embodiments, portable, self-contained system can measure spatially patterned color or light from its environment and display geometry, hue, and brightness-matched patterns using an array of electrochromic devices (ECDs) or electrochromic pixels. The system includes several connected layers that perform sensing, interpretation, signaling, and displaying functions. The layers are connected along an axis in some embodiments, and the axis can be vertical. This layered design can enable the display of environment-matched color and pattern. In some embodiments, the design employs 5-layers. Each layer includes electronic hardware attached to a housing support, all of which are fastened together to produce a self-contained system. In some embodiments, the housing is a plastic or partially plastic housing.

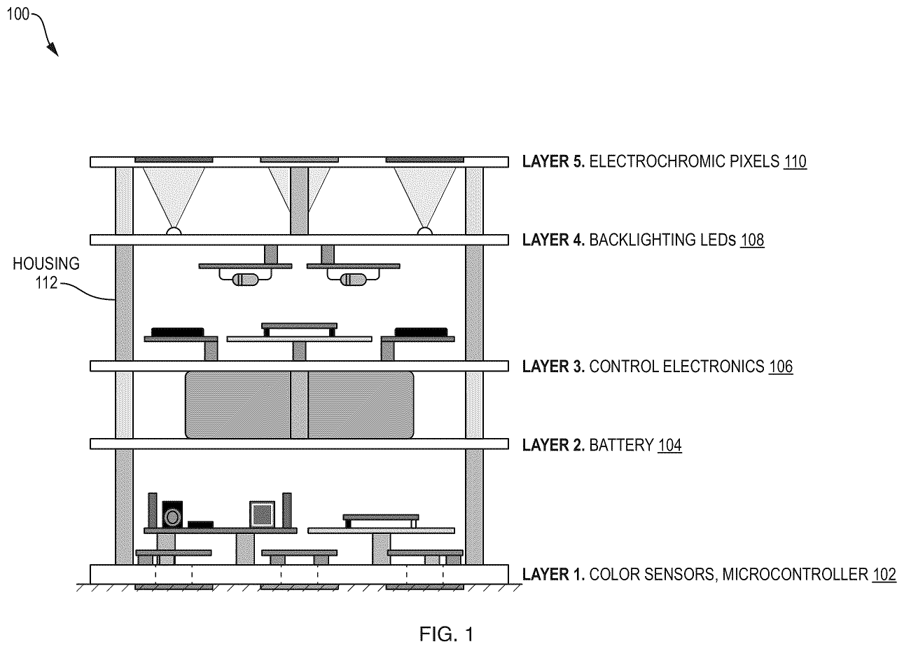

FIG. 1 is a diagram 100 illustrating an example embodiment of a schematic of multilayered device design of the portable, self-contained system. FIG. 1 illustrates a system implemented in five layers, however, a person of ordinary skill in the art can recognize that other numbers of layers can be implemented, for example, by combining layers together or separating layers into two or more layers. Color and pattern are measured on the bottom face of the device by arrayed color sensors, and then replicated on the top face of the device by backlit electrochromic pixels. For simplicity, wiring and electrical connections are not shown in FIG. 1, but a person of ordinary skill in the art could determine wiring and electrical connection details from the description herein.

A color sensor layer 102 of the device includes arrayed reflectance-based color sensors that are oriented to face outward from the housing 112 (e.g., facing the surface on which the device rests, the colored surfaces, or light being measured). The sensors of the layer 102 (e.g., Adafruit TCS34725 board) are in electronic communication with a microcontroller (e.g., Arduino Uno) of the layer 102 via a multiplexing device (e.g., Adafruit TCA9548A board) that enables connection of multiple sensors (e.g., multiple, identical sensors) at once (e.g., in the case of the Adafruit TCA9548A board, up to eight identical sensors at once). These sensors of the layer 102 communicate with the microcontroller (e.g., via the Inter-Integrated Circuit (I²C) protocol). The microcontroller is programmed to receive the signals from the sensors of the layer 102 and can generate signals to control the color and brightness of electrochromic display modules/pixels in layer 110 based on color and/or light intensity values measured at the bottom layer of the system.

The color sensors of layer 102 of the system may be used to perform reflectance-based measurements of colored surfaces using the on-board white LED, or to perform measurements of incident environmental light (e.g., with the on-board LED turned off). To enable the device to be responsive to both forms of stimuli, the microcontroller can switch each sensor's onboard LED on or off. Additionally, the microcontroller can be programmed to automatically turn on or off each sensor's LED based on a detected intensity of incident light.

A battery layer 104 (or battery layer) of the device includes a rechargeable dual-output battery which powers the color sensors, microcontroller, and display elements. The battery connects to the microcontroller and other electronic components using USB connections. In some embodiments, the battery is rated for 2000 mAh, and can power the system for more than one full day or more on a full charge. A person of ordinary skill in the art can appreciate that batteries of different sizes can be employed.

A control electronics layer 106 includes an electronic control hardware for the electrochromic devices on the top face of the system (e.g., layer 110) and backlighting light-emitting diodes (LEDs in layer 108) beneath each electrochromic display pixel. These LEDs provide control over the brightness displayed by each pixel.

To provide access to a range of displayed colors (e.g., oxidized vs. reduced states of the electrochromic pigment), the voltage magnitude and current direction directed through each electrochromic device (ECD) is accurately controlled. To perform on-demand switching of current polarity, which provides rapid color switching in the ECDs, each display pixel is connected to its own H-bridge (e.g., SparkFun TB6612FNG board). The microcontroller generates digital signals that control direction of current flow through each H-bridge. The microcontroller also sends pulse-width modulated (PWM) signals to each H-bridge to control the magnitude of the potential applied to each electrochromic device (e.g., 1.5 V), which determines the intensity of displayed color. To reduce the total number of connections to the microcontroller required for incorporating a multitude of sensing and display elements, both the digital and PWM signals are delivered to each H-bridge using 8-bit shift registers (e.g., Texas Instruments SN74HC595), but the signal can be delivered in other manners in different embodiments. The wires required for power and communication with these hardware components pass through laser-cut holes in the plastic support material of layer 104 to reach the microcontroller.

To control the displayed brightness of each electrochromic element, independently controlled white LED lights can be embedded into the plastic support material for layer 108, such that each embedded LED sits directly beneath an ECD on layer 110. In other words, each embedded LED is operatively positioned to light the ECD such that the ECD color is being shown outside of the housing. The distance between layer 108 and layer 110 is controlled by the height of the fastening hardware (e.g., a Nylon electrical standoff), such that the full area of each ECD is illuminated by a uniform circular pattern of light. As such, this optimal height can depend on the LED strength, LED cone of illumination, and ECD size. The protective resistors for controlling the voltage delivered to each LED are housed on a small circuit board attached to the underside of layer 108. These LEDs are powered by one of the shift registers housed on layer 106.

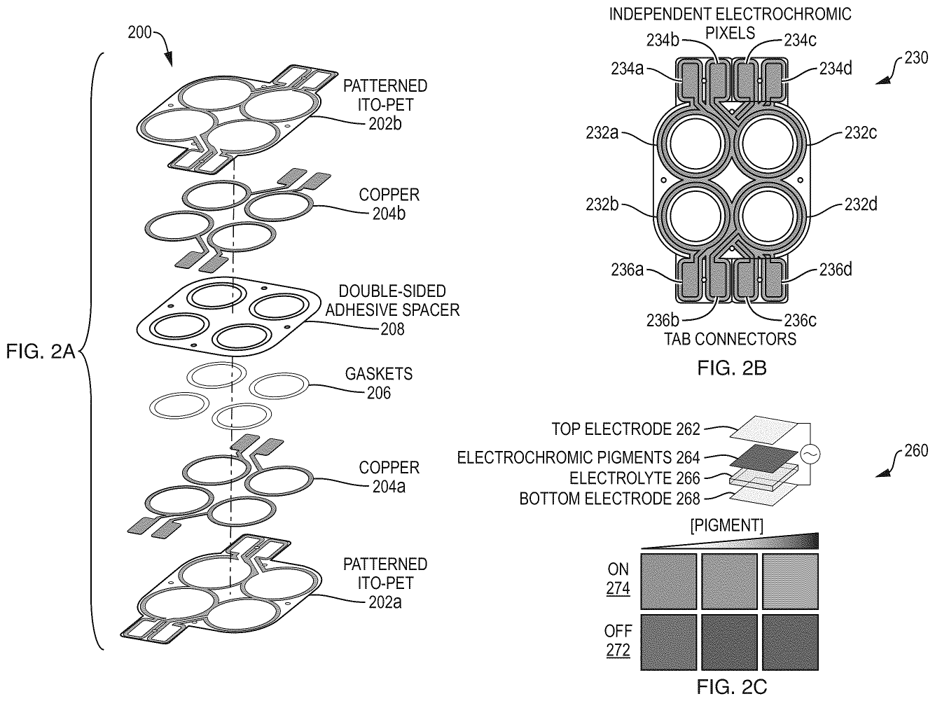

A layer 110 includes the electrochromic devices that are reversibly attached to a plastic support material. The layer 110 can be an outermost layer or one of the outermost layers. These devices are fabricated using laser-cut conductive electrodes made from ITO (e.g., indium-doped tin oxide) coated PET (e.g., polyethylene terephthalate) plastic. Each electrochromic device comprises an uncoated PET electrode connected to an electrical lead made from copper tape, a non-conductive laser-cut PET spacer used to contain a liquid or solid/gel electrolyte, an upper electrode coated in a combination of PEDOT:PSS (poly(3,4-ethylenedioxythiophene) polystyrene sulfonate), an electrochromic polymer, and xanthommatin (Xa), a natural electrochromic pigment found in cephalopods and other animals. The upper electrode is also connected to a lead made from copper tape. Each ECD is constructed using a layer-by-layer assembly approach in which patterned double-sided adhesive is used to seal adjacent layers. Such a construction permits conductivity through the device while protecting opposing electrodes from contacting each other. When an electrical potential is applied across one of these electrochromic devices in the forward or reverse direction, the electrochromic molecules on the top electrode undergo oxidation or reduction reactions that provide changes in reflected visible color. The ECD assembly illustrated in FIGS. 2A-B and accessible color display palette, illustrated in FIG. 2C are described in further detail below. Each electrochromic device can be powered by wire leads connected to the output pins of an H-bridge on layer 106.

The following describes the fabrication of the electrochromic devices. Arrayed xanthommatin-based pixels are prepared by laminating a series of patterned, adhesive-backed plastic films to create independently addressable electrochromic devices. The planar electrodes for each pixel are fabricated by etching a sheet of indium-tin oxide functionalized polyethylene terephthalate (ITO-PET) using a CO₂ laser (e.g., from Universal Laser Systems). Selectively removing the conductive surface layer of a continuous sheet can create spatially separated, geometrically defined conductors within a single piece of material. To achieve sufficient current density across each electrode, planar conductors prepared from adhesive-backed copper tape patterned using a UV laser (e.g., LPKF Laser & Electronics) are incorporated to connect the periphery of each electrode to power. Laminated assemblies comprised of patterned ITO-PET and copper tape are separated by a non-conductive PET film backed on both sides with a pressure-sensitive adhesive (e.g., FLEXcon). This layer contains laser-patterned cutouts that are concentric with the electrodes attached to either side, creating a void volume that is filled with liquid electrolyte (propylene carbonate, 1-butyl-3-methylimidazolium tetrafluoroborate, and hydroquinone) to create a continuous electronic circuit through each electrochromic pixel. A ring-shaped gasket prepared by laser-cutting a soft silicone or Teflon sheet is placed in the center of each pixel during the fabrication process to prevent contamination of the electrolyte by contact with adhesive at the laminated junctions surrounding each electrode. Each pixel is filled with electrolyte via two small-laser-patterned holes in one of the electrode layers.

To achieve rapid color switching using these devices, the working electrodes of each pixel array are patterned with xanthommatin and poly(3,4-ethylenedioxythiophene) polystyrene sulfonate (PEDOT:PSS) by airbrushing. First, a dilute suspension (0.1%, v/v) of PEDOT:PSS (e.g., Sigma Aldrich) in 70% ethanol is sprayed through a laser-cut stencil onto each electrode over a warm hot plate (75° C.) to evaporate the solvent. Next, a suspension of solid reduced xanthommatin in 70% ethanol is sprayed over the PEDOT:PSS base layer to deposit approximately 2 mg of pigment per square inch of the electrode surface. Finally, a second coat of PEDOT:PSS is applied over the xanthommatin layer to sandwich the central pigment layer between two conformal films of the conductive polymer, which facilitates rapid color changes (<1 second) upon reversal of the circuit polarity through each pixel.

FIGS. 2A-C are diagrams illustrating electrochromic device components and a color palette. FIG. 2A is a breakaway diagram 200 illustrating components of the electrochromic device. In FIG. 2A, display pixels are constructed using a pin aligned, layer-by-layer assembly approach. Each pixel is a 5-layer composite of conductive patterned ITO-PET 202a-b, double-sided adhesive 208, adhesive-backed copper tape 204a-b, and non-conductive PET gaskets 206. Electrochromic pigments are coated onto the top electrode, and an electrically conductive electrolyte is contained in a void volume created by the spacer in the center of the device. The geometry and configuration of these layers permit desired layer-to-layer contact but prohibit electrical contacts that would result in device failures.

FIG. 2B is a diagram 230 illustrating that devices assembled by lamination contain independently controlled xanthommatin-based electrochromic pixels 232a-d that are connected to tab connectors 234a-d and 236a-d, respectively. The tab connectors 234a-d and 236a-d can be coupled with a device providing an electrical signal to change the color displayed by the electrochromic pixels 232a-d.

FIG. 2C is a diagram 260 illustrating example embodiments of polarity of the potential applied to an electrochromic pixel changing direction. The electrochromic pixel is shown in a breakaway diagram in FIG. 2C having a top electrode 262, electrochromic pigments 264, electrically conductive electrolyte 266, and bottom electrode 268. When such a polarity change occurs, the color displayed by the pixel alternates between the “On” 274 and “Off” 272 states. The hues of these states are controlled by the amount of pigment that has been coated onto the electrode.

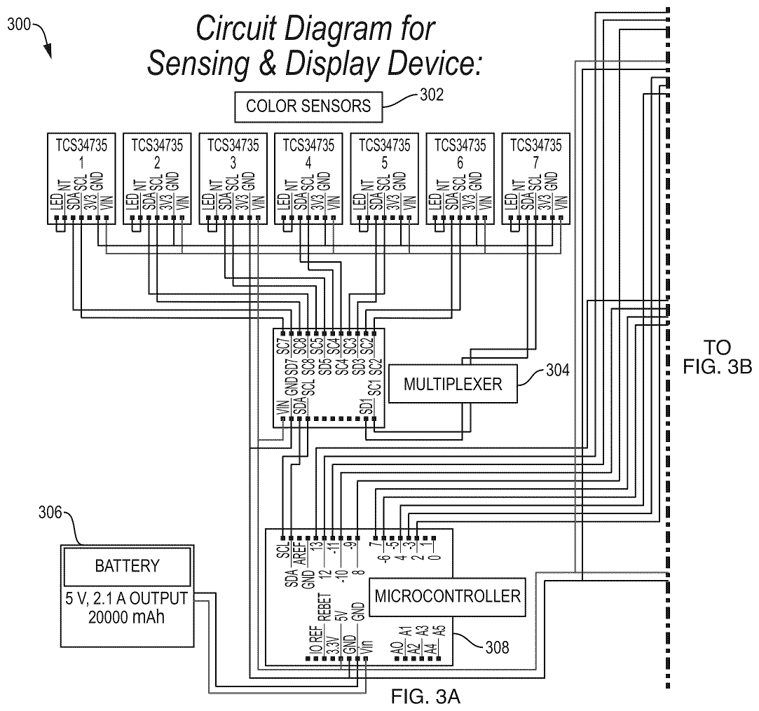

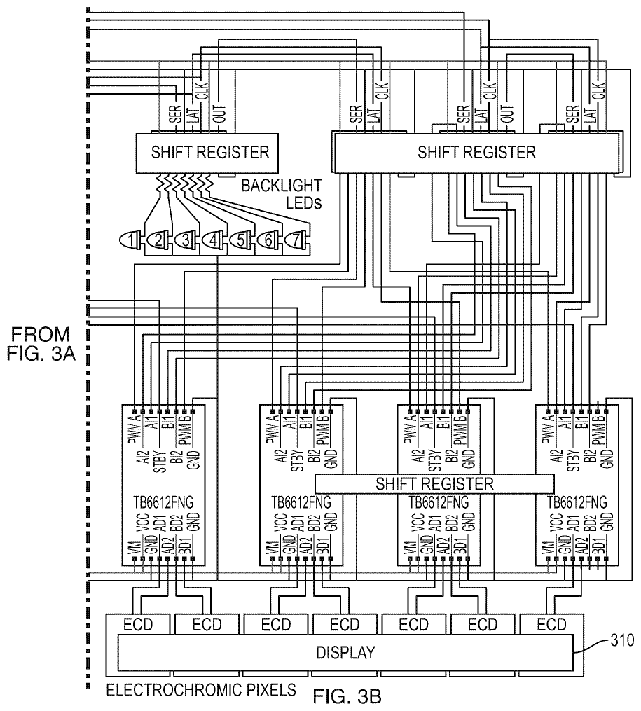

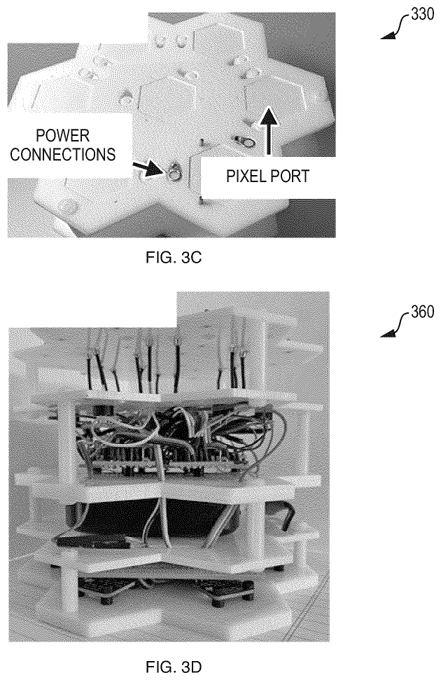

FIG. 3A is a schematic 300 of an example embodiment of the system of the present disclosure. The system includes a plurality of color sensors 302 that are coupled to a multiplexer 304. The multiplexer 304 sends its output to the microcontroller 308, which is powered by a battery 306. The microcontroller then determines one or more signals to send to the display 310 (e.g., of electrochromic pixels/electrochromic devices) via one or more shift registers. It can be seen that based on the schematic, the device can be implemented in the 5-layers described in relation to FIG. 1, or in any number of physical layers, that convert the light received at one or more color sensors to electrical signals that control electrochromic pixels.

FIG. 3B is a photograph 330 illustrating a top view of an example integrated prototype of the system. FIG. 3C is a photograph 360 illustrating a side view of an example integrated prototype of the system. In some embodiments, the device is approximately five-inches tall. In some embodiments, the design includes one physical layer that will include all embedded sensing and display components by designing an application-specific integrated circuit.

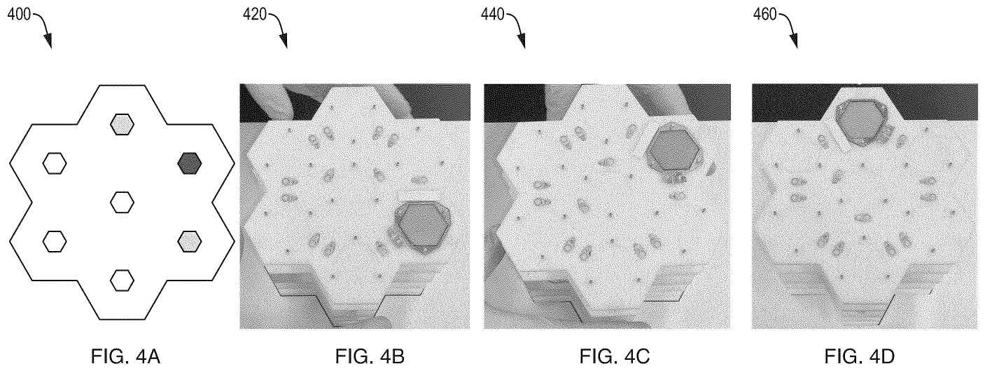

FIG. 4A is a diagram 400 illustrating a pattern placed on paper for sensing by the color sensors. FIGS. 4B-D are photographs 420, 440, and 460 illustrating a setup to evaluate the system including observing rapid color changes in the electrochromic pixels on the top layer of the devices in response to color changes measured by the sensors at the bottom of the device. As shown by Figs. B-D, the pixel displays a different xanthommatin oxidation state corresponding to the color of the pattern illustrated in FIG. 4A. A person of ordinary skill in the art can recognize that other embodiments of the device can be implemented by the present disclosure and schematics, including independent, decoupled hardware components that communicate wirelessly.

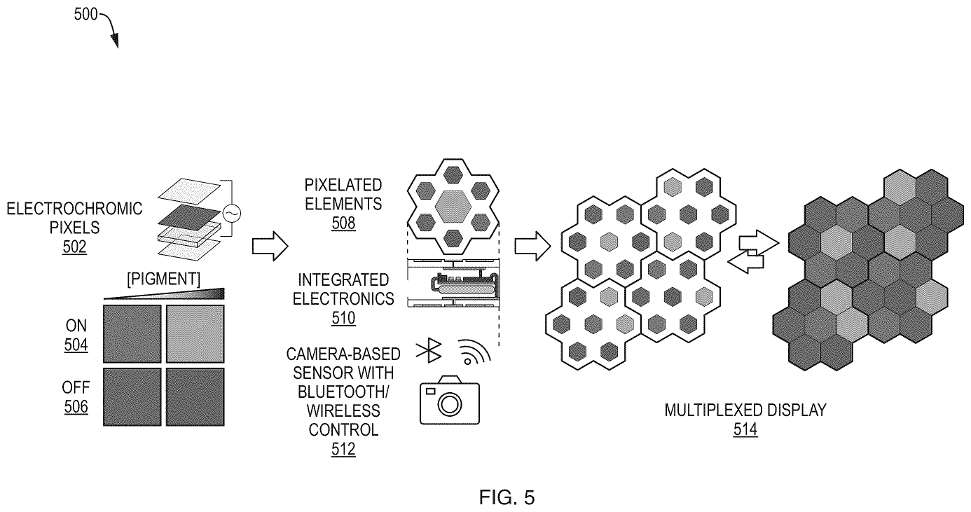

FIG. 5 is a diagram 500 illustrating one example of a wireless implementation. Electrochromic pixels 502 configured to adjust pigment based on whether a signal is on 504 or off 506. A group of the electrochromic pixels 502 form pixelated elements 508, and are coupled with integrated electronics 510 (e.g., one or more of a microprocessor, lighting, control electronics, signal generation hardware). A camera-based sensor with wireless control (e.g., Bluetooth, WiFi) 512 can transmit sensed color to the integrated electronics 510, which determines signals to send to the pixelated elements 508 based on the sensed color. A multiplexed display 514 based on the pixelated elements 508 can then display the colors sensed by the camera 512 by adjusting the signals to each pixelated element 508. In this manner, networks of connected sensing and display devices (e.g., multiplexed display 514) could be used to control environment-matched color and pattern over large surface areas.

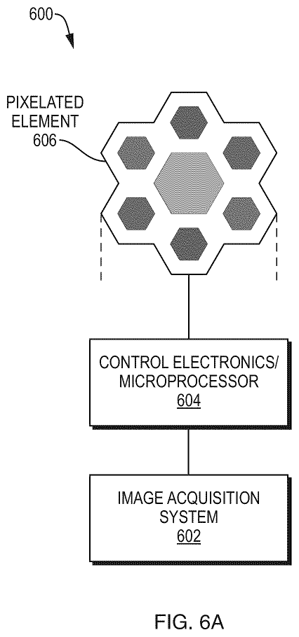

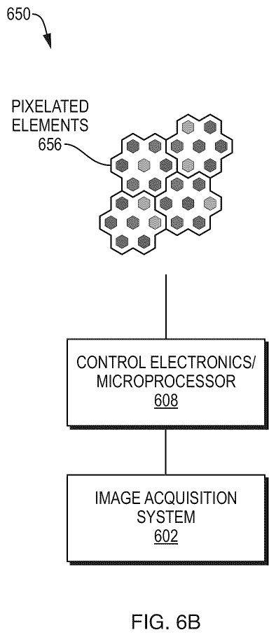

FIG. 6A is a block diagram 600 illustrating an example embodiment of the present disclosure. An image acquisition system 602 is coupled with control electronics 604 (e.g., microprocessor, signal generation processor). The signals can be generated by the electronics 604 to control one or more of the pixelated element 606. In one embodiment, the pixelated element 606 includes a group of individual electrochromic pixels that each may have a variety colored pigments across the group, such that the control electronics 604 can generate a signal to one or a combination of the individual pixels of the pixelated element 606 such that a specific color is generated by the element 606.

FIG. 6B is a block diagram 650 illustrating an example embodiment of the present disclosure. An image acquisition system 602 is coupled with control electronics 604 (e.g., microprocessor, signal generation processor). The signals can be generated by the electronics 604 to control one or more of the pixelated element 656. In one embodiment, the pixelated elements 656 include multiple pixelated elements, each pixelated element including a group of electrochromic pixels, including a variety of individual colored pigment, such that the control electronics 604 can generate a signal to one or a combination of the individual pixels of the pixelated element 606 such that a specific color is generated by the element 606.

In some embodiments of the present disclosure, applications of xanthommatin are presented to create laterally arrayed electrochromic pixels (ECPs) is presented. When formulated in a poly(3,4-ethylenedioxythiophene) polystyrene sulfonate (PEDOT:PSS) vehicle, Xa-based ECPs can be processed in a mild annealing step to introduce localized conductivity that activates its electrochromic function. This feature is enabled by the printed, open-design configuration of each ECP which facilitates electron transfer across electrically isolated boundaries upon application of +1.5V to trigger reversible color change within approximately 2.5 minutes—a process that can sustain operation for over 42 hours of continuous cycling with minimal deviation in the displayed colors. While these changes are currently slower than traditional, sandwiched electrochromic devices cast onto conductive substrates, they represent an important step towards the incorporation and practical use of new active materials like Xa as low-power, color-changing pixels that are accessible in any environment.

Biomimetic systems designed to approximate chromatophore structure/function properties have been iterated over the past decade with more recent strategies based on mechanochromism, magnetochromism, thermochromism, and photochromism. Many of these technologies have demonstrated impressive strategies to control shape, color, and in some cases, patterns built to mimic the high speed, cooperative display changes in cephalopods. However, they remain challenged by requirements for complex control hardware, electrically expensive actuation strategies, and/or unsustainable materials that limit their use for many practical applications.

In an embodiment, one strategy to overcome some of the intensive power requirements and throughput challenges associated with many of the cephalopod mimetic or inspired technologies is the use of electrochromic materials. Electrochromic devices rely on a voltage-activated electrochemical reaction that modulates the transmission of light and/or color value, typically in the visible color spectrum. Given that these chemical reactions typically require low (e.g., <5 V) voltages and sometimes require no continuous application of current to maintain a given transmissivity, they can result in ultra-low powered optical devices. “Ultra-low” power for display technology is typically defined as less than 10 mW cm⁻², but ECDs can frequently maintain a colored state with near-zero power consumption and operate at less than 1 mW cm⁻² when switching states.

While there is a variety of different types of electrochromic materials including metal oxides, small molecules, and conductive x-conjugated polymers, conductive polymers have emerged as a promising, cost-effective material amenable to multi-material integration and manufacturing. Of the variety of conductive x-conjugated polymers poly(3,4-ethylenedioxythiophene):poly(styrenesulfonate) (PEDOT:PSS) is perhaps the most commonly used because of its ability to form a dispersion in water, tunable conductivity, biocompatibility, and highly reversible transparent (oxidized) to dark blue (reduced) color change. Despite the relatively low inherent conductivity (approximately 0.2 S cm⁻¹), when the PEDOT regions are allowed to aggregate, the PEDOT and PSS sections can separate and increase the size of individual PEDOT regions, thereby improving conductivity (approximately 10.0 S cm⁻¹). This, combined with advancements in simple post-processing techniques, including solvent treatments with ethylene glycol (now commonly included in commercial formulations of PEDOT:PSS), DMSO, sulfuric acid, and methanesulfonic acid, results in improved conductivities (2000-4000 S cm⁻¹).

There are currently multiple ways of preparing electrochromic devices with spin coating, screen printing, electrodeposition and spray coating being most commonly used. However, these top-down methods require a significant amount of starting material for successful casting, much of which is applied in excess and often discarded as waste. An alternative to these methods is piezoelectric inkjet printing (IJP), which allows for the precise and reproducible deposition of ink from the bottom up-a process that minimizes waste by eliminating the need for masking or aligning steps for drop-on-demand deposition and subsequent patterning. With piezoelectric IJP specifically, the voltage and frequency of each waveform can be manipulated to deform the piezoelectric printhead to expel a droplet from each nozzle (typically, between 1-12 nozzles). Because of the flexibility of IJP, generally any aqueous ink with viscosities ranging from 8-40 mPa·s and surface tensions of 40 mN m⁻¹ can be optimized for printing through a user-controlled waveform. Recent work has even seen the development of inkjet-printed electrochromic devices utilizing PEDOT:PSS for wearable display, electrode array and sensor applications.

The method and system of this disclosure leverages the adaptive features of inkjet printing together with the biochrome xanthommatin (Xa), commonly found in the skin of cephalopods, to create electrochromic pixels (ECPs) with colors that expand beyond the blue/clear states of traditional PEDOT:PSS in design schemes that produce low-power displays. As a redox-active chromophore, Xa can undergo a voltage-triggered color change from yellow (oxidized) to red (reduced), which can be demonstrated in manually prepared devices templated on PEDOT:PSS coated indium-tin oxide (ITO) substrates. The PEDOT:PSS matrix offers advantages of conductivity and charge transfer needed to facilitate color change, while Xa, introduced at significantly lower weight percentages than the matrix, dominates the visible color changes. Despite the excellent device performance and colors displayed, practical applications these devices were limited due to their manufacturing constraints, highlighting a need to re-approach how these devices are produced.

In some embodiments, a formulation and characterization of inkjet-printed, Xa-based ECPs demonstrates the ability to scale and control an array of pixels. In the design disclosed herein, each ECP is built laterally to minimize the number of post-print processing and assembly steps needed to build and array functional devices. These printed electrodes are spatially separated to serve as both conductors and display elements, illustrating their potential as electroactive, color-changing units.

In some embodiments, prior to printing, a fresh ink is formulated containing newly synthesized Xa. To create the formulation, in some embodiments, 3-hydroxykynurenine (4 mg, 17.8 μmol) (3OHK) is dissolved in sodium hydroxide (25 μM, 1 mL) and mixed dropwise with a solution of potassium ferricyanide (16.5 g, 50.1 μmol) dissolved in deionized water (0.5 mL). The reaction is then covered and left stirring at room temperature for 90 minutes. The resulting Xa is precipitated by addition of 1 M hydrochloric acid (0.5 mL) followed by treatment with DI water over multiple centrifugation and wash cycles (e.g., Eppendorf Centrifuge 5254).

In some embodiments, to print lateral electrochromic pixels, a piezoelectric inkjet printer (e.g., a Dimatix Materials Printer, DMP-2850) is employed for printing. The inks are formulated with freshly synthesized Xa dissolved in a pH 6, 0.050 M MES (2-(N-morpholino)ethanesulfonic acid) buffer mixed with PEDOT-Jet40 ink (Pedotinks.com) to produce a final concentration ranging from greater than 0 to 3 mg mL⁻¹ Xa. The inks are filtered through a 1-μm polytetrafluoroethylene syringe filter (e.g., Thermofisher) before loading into a Samba print cartridge chamber (e.g., Fujifilm) compatible with the inkjet printer. The cartridges are then degassed in a vacuum chamber for 30 minutes. Prior to printing, the 0.1 mm thick sheets of polyethylene terephthalate (PET) are washed, dried, and treated with a UV-ozone cleaner (e.g., Jetlight, Model 30) for 30 minutes. Then, the pixels are printed at room temperature, about 22° C., where 1-5 nozzles were employed consistently with a 33-kHz jetting frequency at 39 V. Following printing, the patterns are annealed at 60° C. For the full-scale device each pattern includes two spatially separated electrodes with the same area (e.g., 1.7 cm²). The gap between each electrode was 1 mm, and each had 1 cm leads extending from their edges to facilitate connecting to the external power supply. This is uniformly scaled down for the 50% and 25% sized devices by their respective amounts.

In some embodiments, assembling the electrochromic pixels can be performed as follows. After printing and annealing, the outer borders of the ECPs are sealed with a inert gasket, such as a thin polydimethylsiloxane (PDMS) gasket (e.g., Sylgard™ 184 Silicone Elastomer Kit), to create an open-faced chamber for the electrically conductive electrolyte during testing. Then, a UV-curable glue (e.g., Bondic) is applied to the edge of this gasket to prevent leakage of the liquid electrolyte (e.g., propylene carbonate (2 g), 1-butyl-3-methylimidazolium tetrafluoroborate (1.6 g), and hydroquinone (0.003 g)).

In some embodiments, a Z-value is calculated as follows. First, all inks for printability are characterized using the reciprocal of the Ohnesorge number: (Z value, Equation 1).

$$Z = \frac{{( d ρ γ )}^{\frac{1}{2}}}{η} \qquad ( 1 )$$

Here, density (ρ) is determined by measuring the mass of 100 μL of the ink with an analytical balance (e.g., VWR-225AC). Viscosity (η) is measured using, for example, a Discovery Hybrid Rheometer-2 (TA instruments) using a standard-size 40-mm 1° cone (TA instruments) and plate geometry. These measured viscosities are derived under a ramp shear rate of 1-100 s⁻¹ over 5 minutes. Surface tension (γ) is measured with, for example, an Attension Theta optical tensiometer (e.g., from Attension Instruments). Finally, the drop diameter (d) is calculated based on the assumption that a 2.4 pL spherical drop (diameter of 1.66 μm) is produced from each nozzle during printing. All inks are characterized with n=3 measurements per sample. A person of ordinary skill in the art can recognize that other devices and instrumentation can be employed.

In some embodiments, the characterization of printed patterns is performed as follows. Conductivity and resistance are measured with an Ossila 4-point probe. During testing, 1 cm by 1 cm square patterns are measured, making three measurements per square pattern across three independent patterns. Thickness similarly (e.g., three measurements over three samples) using, for example, a Dektak 3030CR Profilometer. The static patterns are imaged, for example, using an Epson Perfection V19 scanner with a resolution of 300 dpi in picture color mode with a white background. A person of ordinary skill in the art can recognize that other devices and instrumentation can be employed.

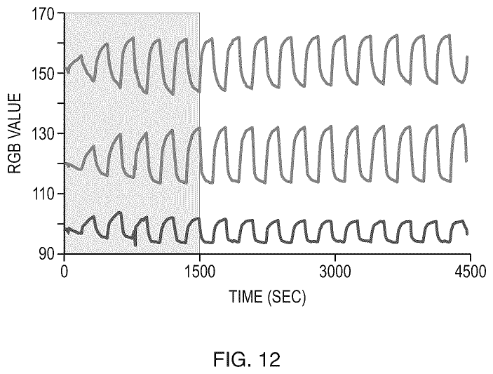

In some embodiments, electrochemical characterization can be performed as follows. The chronoamperometry profile of the ECPs is collected using, for example, a Gamry Interface 1000B Potentiostat under +/−1.5 V versus the reference electrode in a two-electrode setup with the reference electrode shorted to the counter electrode for 150 seconds each. Before collecting data, each device is run for five cycles. These preconditioning steps functioned to standardize the remaining data collected over the next 10-500 cycles, and the results are shown in the graph of FIG. 12.

FIG. 12 is a graph illustrating an RGB analysis of the first 15 cycles of a 7-layer printed PEDOT-Xa ([Xa=2 mg mL⁻¹) ECP. In FIG. 12, grey colored region highlights the first 5 cycles of the device that are not considered in later performance characterization. Red, green, and blue colored lines correspond to their respective RGB channels.

For the duration of the experiment, the current at every second is recorded. In some embodiments, for longer term experiments (e.g., more than 10 cycles), data points can be collected less frequently, such as every 10 seconds. The experiments are performed across independent pixels, such as three independent pixels.

For colorimetric analysis, camera(s) captured videos of the ECPs using devices such as, but not limited to, an iphone 8 plus (e.g., 12-megapixel resolution camera, 60 frames per second, using Adobe® Premiere Rush as the video collection application) or a time-lapse camera (e.g., a Brinno TLC2020). The time-lapse camera was used exclusively for studies of greater than 10 cycles, wherein capturing a single frame every 10 sec is acceptable, however, a person of ordinary skill in the art can recognize that other time periods can be employed. In each case, these videos are deconstructed into a single photo every 10 (e.g., fewer than 10 cycles) or 30 seconds (e.g., greater than 10 cycles) with a video editing software (e.g., Videoproc Converter). The images are compiled into an image sequence that was analyzed with, for example, ImageJ and a custom-built macro. The image analysis software package measures associated RGB values of the inner and outer electrodes over the course of the image sequence with RGB Measure, an ImageJ plugin (e.g., https://imagej.nih.gov/ij/plugins/rgb-measure.html).

To control the printed 4-pixel electrochromic pixel arrays, a microcontroller-based power supply controls the redox states of the pixels individually. This system used a standard microcontroller (e.g., Arduino Uno) to control the magnitude and polarity of voltages directed through each ECP using H-bridge breakout boards (e.g., SparkFun Electronics), enabling control of the oxidation states of electrochromic blends in timed sequences. However, a person of ordinary skill in the art can recognize that other hardware and processors can be used. The electronics apply +/−1.5 V across each ECP to induce redox changes, and the cycles lasted for 300 seconds.

In formulating Xa-based inks, the role of concentration on printability, conductivity, and color is investigated. To start, up to 3 mg mL⁻¹ Xa is incorporated into a PEDOT:PSS vehicle. The fluid physical properties of the modified inks are then characterized using a theoretical Z-value calculation that relates viscous forces to inertial forces and the solution surface tension needed for inkjet printing (see, e.g., Equation 1 above).

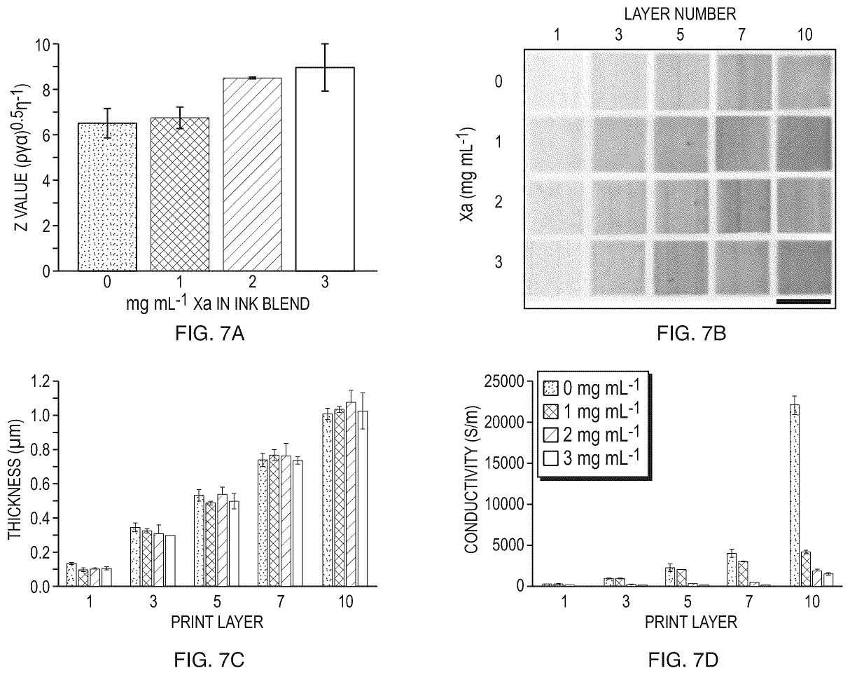

FIG. 7A is a graph illustrating calculated Z-values corresponding to the PEDOT-Xa ink blends of Xa incorporated inks. The Z-values derived for inks formulated with 0, 1, 2, and 3 mg mL⁻¹ Xa were 6.56±0.66, 6.80±0.48, 8.57±0.06, and 9.04±1.04, respectively. The addition of Xa increased the Z-values due to its increased density contributions, but all values fell between the specified 1-10 range recommended for successful printing. Error bars represent standard deviation of n=3 replicates per condition. Scale bar corresponds to 1 cm.

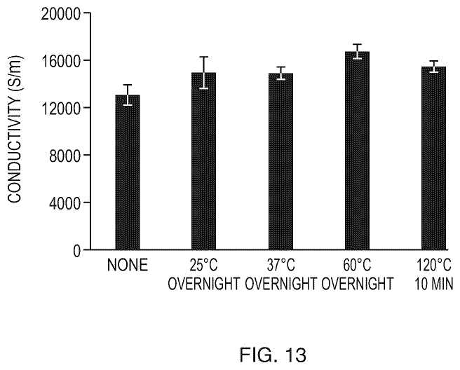

FIG. 7B is an image of 1 cm² patterns of the PEDOT-Xa ink blends ([Xa]=greater than 0 to 3 mg mL⁻¹) as a function of print layer count. This theoretical result was verified by printing simple squares and characterized all patterns on a non-conductive PET substrate, selected intentionally to eliminate the need for conductive substrates like indium tin oxide (ITO) coated glass or plastic. Because the lateral ECP design requires electrically isolated anodes and cathodes, annealed PEDOT:PSS serve this function by leveraging their natural conductivity. To achieve this, the devices were cured overnight in a 60° C. oven, a process which facilitated complete evaporation of the liquid phase from the printed patterns optimized to drive an increase in conductivity. FIG. 13 is a graph illustrating methods of curing and resulting conductivity, including no curing, 25° C., 37° C., 60° C., 120° C. Next, the number of printed layers are varied (1, 3, 5, 7 and 10) and thickness and conductivity changes are evaluated in each.

FIG. 7C is a graph illustrating thickness of the 1-cm² patterns depicted in FIG. 7B. Thicknesses ranged from 0.108±0.015 μm (1 printed layer) to 1.031±0.025 μm (10 printed layers). These thickness values were used together with each pattern's surface resistivity to calculate sample conductivity. Error bars represent standard deviation of n=3 replicates per condition. Scale bar corresponds to 1 cm.

FIG. 7D is a graph illustrating conductivity of the 1-, 3-, 5-, 7- and 10- layer patterns depicted in FIG. 7B. While conductivity increased as the printed layer count increased across all patterns, the increasing concentration or presence of Xa lowered all measured values.

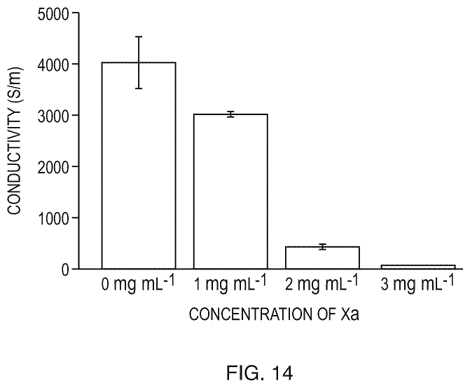

FIG. 14 is a graph illustrating an effect of Xa concentration on conductivity in a 7-layer pattern that compares the conductivity of 0, 1, 2 and 3 mg mL⁻¹ Xa ink blends when printed in a 7-layer pattern, where the error bars represent standard deviation of n=3 replicates per condition. This effect was likely a result of higher defects in the annealed polymer network with Xa, which decreased entanglement and ultimately conductivity when compared to the control (no Xa). Error bars represent standard deviation of n=3 replicates per condition. Scale bar corresponds to 1 cm.

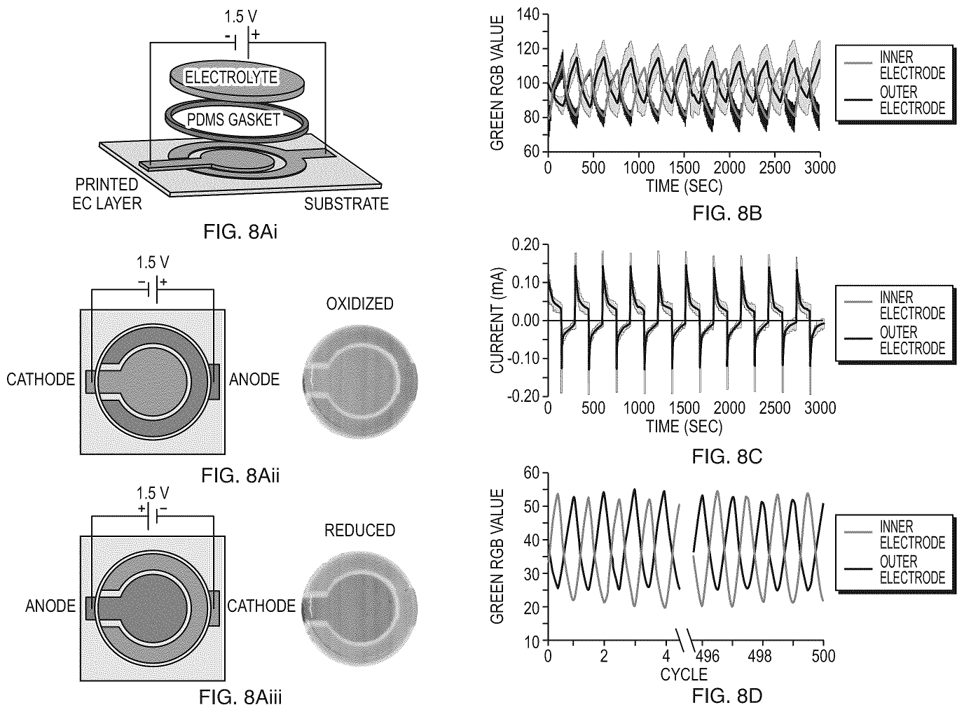

FIG. 8A(i) is a diagram illustrating an example embodiment of a schematic of device assembly of a device with a potential of 1.5V. FIG. 8A(ii) is a diagram illustrating an example embodiment of schematics of the device of FIG. 8A(i) and an image of the device in oxidized state. The potentials being applied to the device are −1.5V and +1.5V, respectively. To test whether these processed inks could still activate color change when patterned as lateral pixels this, each pixel is printed as two adjacent electrodes spatially separated on a continuous substrate, where the printed inner and outer electrodes had the same surface area with different geometries—an important design feature for balancing charge transfer in this device. In this configuration, a flexible PDMS gasket is positioned over each pixel to contain an ionic liquid electrically conductive electrolyte and the device is connected in series with an external power supply to control the voltage at each electrode. Color and color change across the electrodes were characterized through pixel intensity measurements, where individual RGB values associated with each electrode over 10 cycles were recorded to understand color evolution upon application of a voltage.

FIG. 8A(iii) is a diagram illustrating an example embodiment of schematics of the device of FIG. 8A(i) and an image of the device in reduced state, where the scale bar represents 1 cm.

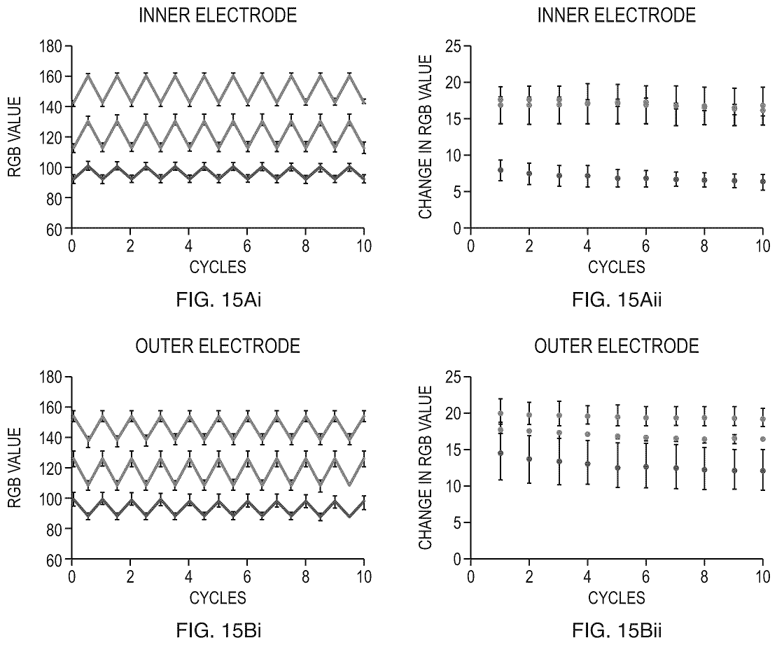

Upon analysis of the RGB color channels, the largest difference in signal is in the green channel, which was then used to compare across multiple devices. FIGS. 15A-B illustrate raw value and changes in RGB values for each color for the inner electrode and outer electrode, respectively. RGB analysis as a metric can be inherently highly dependent on relative imaging conditions, making it difficult to compare raw values across multiple devices. Thus, the change in the green channel (ΔGreen) is used, as opposed to the raw values, when comparing performance across different devices. Using this metric, the effect of Xa concentration on color development is analyzed in the present system (e.g., a 7-layer system). An observed ΔGreen value of 9.3±3.4 is provided by use of the inner electrode of devices printed with 1 mg mL⁻¹ Xa, despite its relatively high conductivity. At 3 mg mL⁻¹ Xa, selective areas were observed with more vibrant colors from Xa, even though it had the lowest overall conductivity; however, the overall color uniformity was inconsistent with no discernible changes in color with voltage, making it challenging to analyze the color change in a meaningful way.

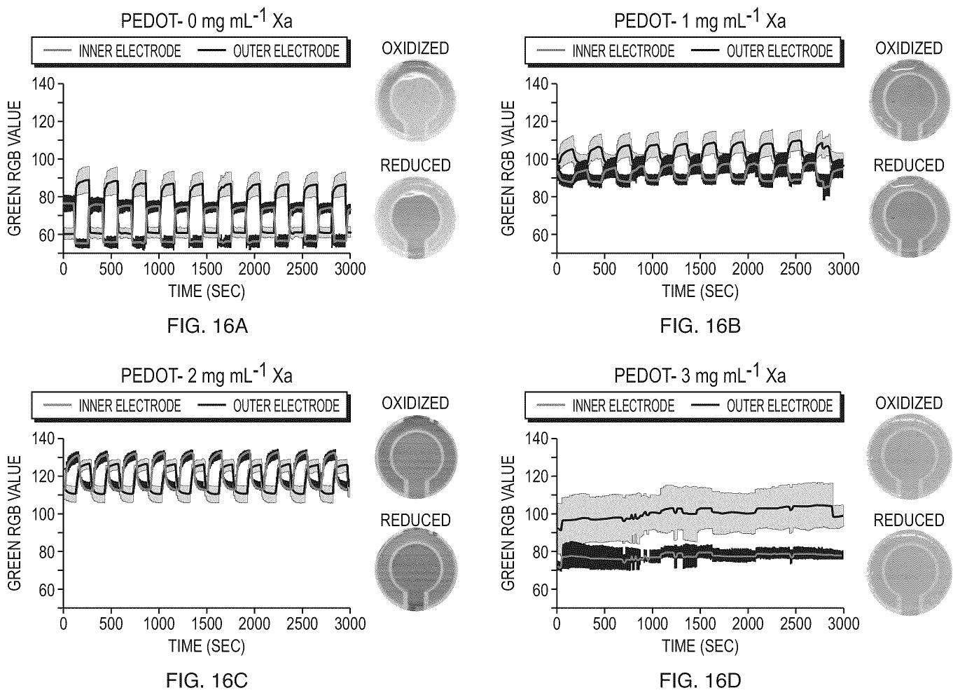

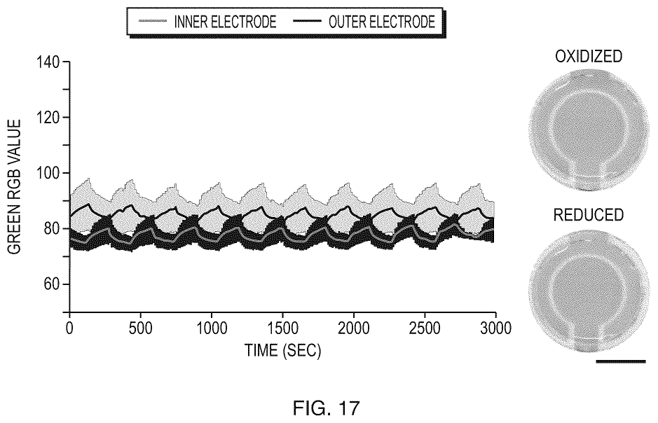

FIGS. 16A-D are graphs illustrating green RGB values for the inner electrode and outer electrode of concentration effects on accessible color space of the 7-layer ECP for PEDOT of 0 mg/ML of Xa, 1 mg/ML of Xa, 2 mg/ML of Xa, 3 mg/ML of Xa. Green channel color analysis of the Xa ink blends (A) 0, (B) 1, (C) 2 and (D) 3 mg mL⁻¹ with associated photos of the devices in oxidized and reduced states, where error bars represent standard deviation of n=3 replicates per condition with scale bar corresponding to 1 cm. The 2-mg mL⁻¹ Xa (FIG. 16c) condition yielded the most consistent colors that were preserved over multiple cycling events with the largest ΔGreen of 19.5±0.9. To investigate the effect of print layers on color development, the emergence of visibly contrasting colors in the 7- and 10-layer devices were observed, resulting in ΔGreen values of 19.5±0.9 and 22.8±2.4 respectively. Visible colors observed from devices printed with 5 or fewer layers were challenging to differentiate, producing ΔGreen values of or under 5.8±2.8. FIG. 17 is a graph illustrating the green RGB values over time for devices printed with 5 or fewer layers.

FIG. 8B is a graph of a normalized green RGB value tracked over 10 cycles of device function alternating between +1.5 V and −1.5 V every 150 seconds. Moving forward, the 10-layer 2 mg mL⁻¹ Xa formulation was used to build and test the ECPs. In these conditions, reproducible cycling was used between the reduced and oxidized states for both the outer and inner electrodes with minimal decay in the green color intensity over 10 cycles. Scale bars correspond to 1 cm. Error bars in FIGS. 8B and 8C represent standard deviation of n=3 replicates per condition.

FIG. 8C is a graph of chronoamperometry results showing the current across the device during cycling as described in relation to FIG. 8B. The scale bars of the graph correspond to 1 cm. Chronoamperometry was used together with video imaging to understand color evolution and reproducibility over time.

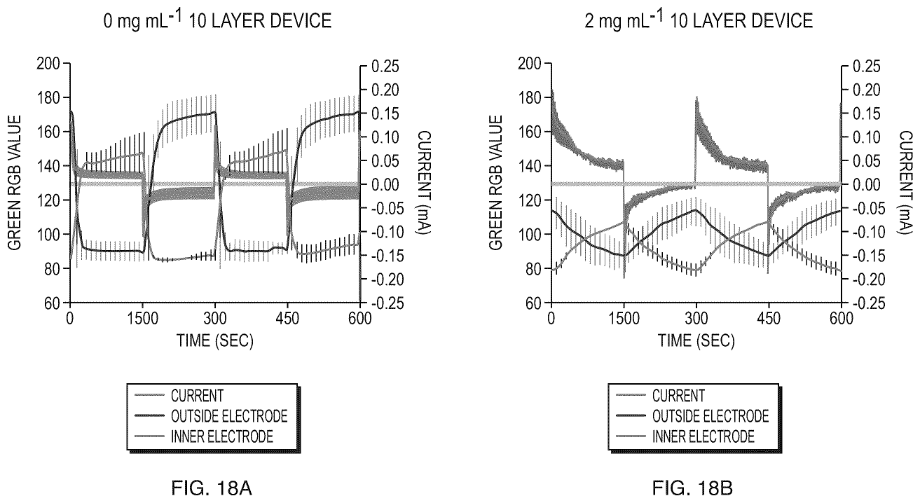

FIGS. 18A-B illustrate green RGB values over time for a 0 mg/ml Xa 10-layer device and a 2 mg/mL Xa 10-layer device, respectively. Maximal color contrast appeared within 150 seconds, which is 15× longer than the PEDOT control patterns.

FIG. 18A is a graph illustrating an overlay of the green channel color analysis and the chronoamperometry data collected for 10-layer 0 mg mL⁻¹ Xa ECP, where error bars represent standard deviation of n=3 replicates per condition.

FIG. 18B is a graph illustrating an overlay of the green channel color analysis and the chronoamperometry data collected for 10-layer 2 mg mL⁻¹ Xa ECP, where error bars represent standard deviation of n=3 replicates per condition.

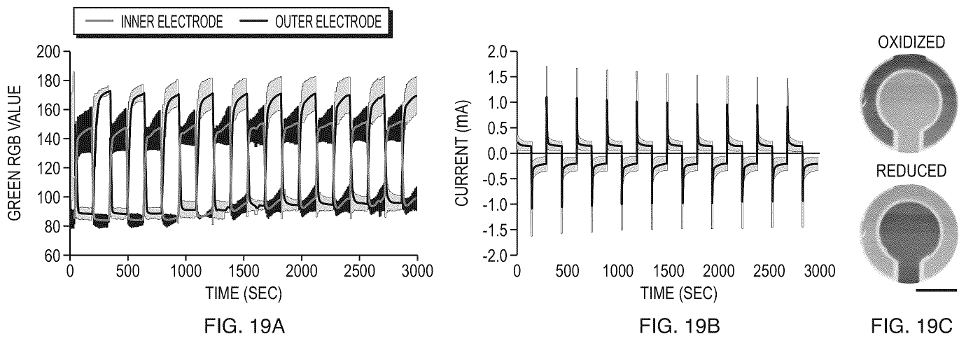

FIG. 19A is a graph illustrating a characterization of control pattern, illustrating a normalized green channel value for the 10-layer device for 0 mg mL⁻¹ Xa ECP tracked over 10 cycles device function alternating between +1.5 V and −1.5 V every 150 seconds, where error bars represent standard deviation of n=3 replicates per condition and the scale bar corresponds to 1 cm.

FIG. 19B is a graph illustrating a characterization of control pattern, illustrating chronoamperometry results showing the current across the device during its cycling as described in FIG. 19A, where error bars represent standard deviation of n=3 replicates per condition and the scale bar corresponds to 1 cm.

FIG. 19C is a photograph of the oxidation state in a physical device. The scale bar represents 1 cm.

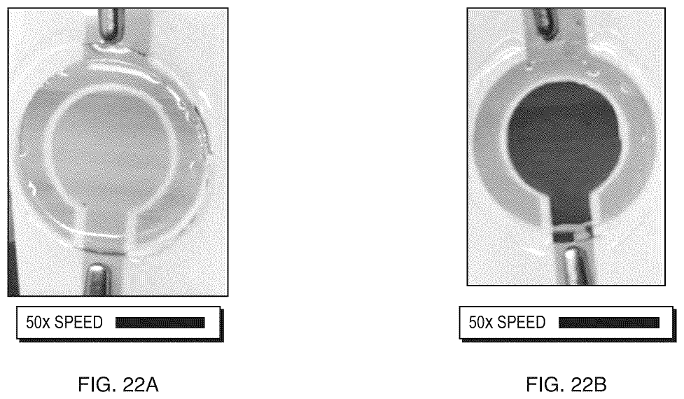

FIG. 22A is a photograph of a 10-layer 2 mg mL⁻¹ Xa device color cycling at 50× speed with a scale bar corresponding to 1 cm.

FIG. 22B is a photograph of a 10-layer 0 mg mL⁻¹ Xa device color cycling at 50× speed with a scale bar corresponding to 1 cm.

The difference between the photographs of FIG. 22A and FIG. 22B is again attributed to the differences in conductivity with the inclusion of Xa, demonstrating an important trade-off that should be considered in applications of the ECPs.

FIG. 8D is a graph illustrating color analysis of the first and last 5 cycles of the ECPs function over a 500-cycle test period. Despite this slower response time, each pixel maintained operation over 500 cycles, equating to 41 hours and 40 minutes of use (5-minute cycle times) with minimal degradation in color or performance, demonstrating its sustained function over multiple days under these conditions. The scale bars of FIGS. 8A-D correspond to 1 cm. Error bars in FIGS. 8B and C represent standard deviation of n=3 replicates per condition.

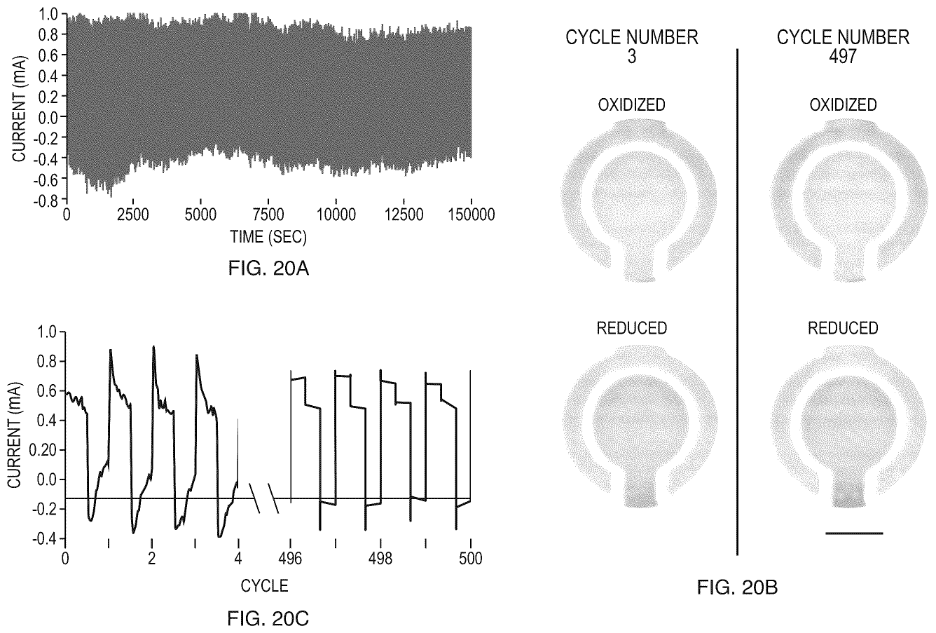

FIG. 20A is a graph illustrating a characterization of the 10-layer 2 mg mL⁻¹ Xa ECP over 500 cycles showing chronoamperometry data for the 500 cycles, with the scale bar corresponding to 1 cm. FIG. 20B illustrates color at cycle 3 of a pixel and cycle 497, illustrating sustained performance, with the scale bar corresponding to 1 cm. FIG. 20C is a graph illustrating current over cycles.

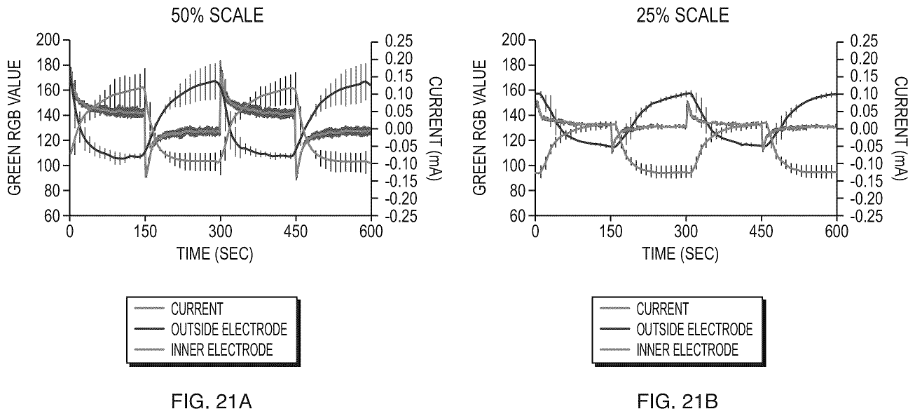

FIG. 21A is a graph illustrating an overlay of the green channel color analysis and the chronoamperometry data collected for the miniaturized devices for a 10-layer 2 mg mL⁻¹ Xa 50% scale device, where error bars represent standard deviation of n=3 replicates per condition.

FIG. 21B is a graph illustrating an overlay of the green channel color analysis and the chronoamperometry data collected for the miniaturized devices for a 10-layer 2 mg mL⁻¹ Xa 25% scale device, where error bars represent standard deviation of n=3 replicates per condition.

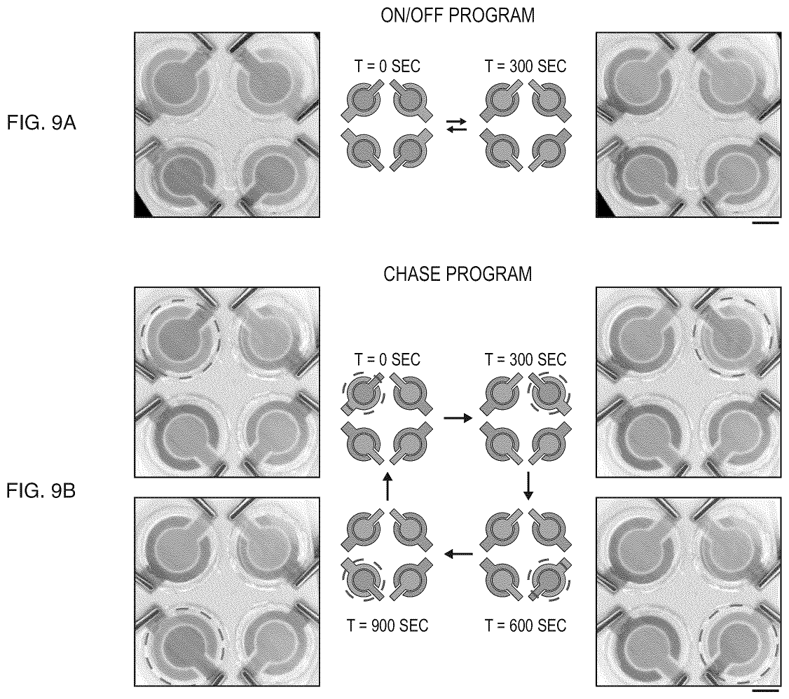

FIGS. 9A-B are diagrams and images illustrating schematics of a 4-pixel device and demonstrate display capabilities of the ECP. A 4-pixel array demonstrates that it is possible next expand and selectively control an array of ECPs in a proof-of-concept display application. To test this, a 4-pixel demo is printed using a slightly modified design that enabled access to leads via an off-board microcontroller. By creating timed sequences of control signals delivered to each pixel, a series of programs where define each pixel by the color state of the inner electrode. Red dashed circle highlights the pixel undergoing reduction, and scale bars correspond to 1 cm.

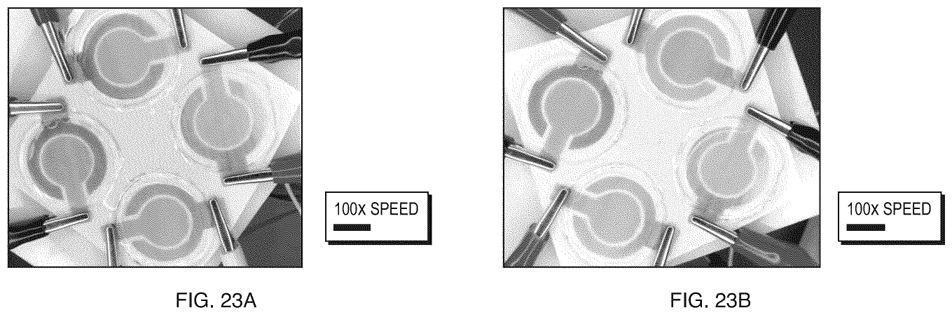

FIG. 9A is a diagram and images illustrating a schematic of a 4-pixel device with an on off microcontroller program. In the first demonstration, a program executes a simple on off program, wherein the device cycles between all 4 pixels being reduced or oxidized with the application of a +/−1.5 V. FIG. 23A is a photograph of a 10-layer 2 mg mL⁻¹ Xa 4-pixel device color running the On Off program at 100× speed with a scale bar corresponding to 1 cm.

FIG. 9B is a diagram and images illustrating a schematic of a 4-pixel device with a chase microcontroller program. In the second demonstration, a chase program executes operations that reduce a single electrode and the other three electrodes are oxidized clockwise, resulting in a pattern of all four pixels cycling over the course of a 20-minutes. These operations are repeated for all the pixels to induce the display pattern indicating a pixel cycling around a wheel. When taken together, this data illustrates the ability to program colors and color change of multiple, electrically isolated ECPs on one substrate. FIG. 23B is a photograph of a 10-layer 2 mg mL⁻¹ Xa 4-pixel device color running the Chase program at 100× speed with a scale bar corresponding to 1 cm.

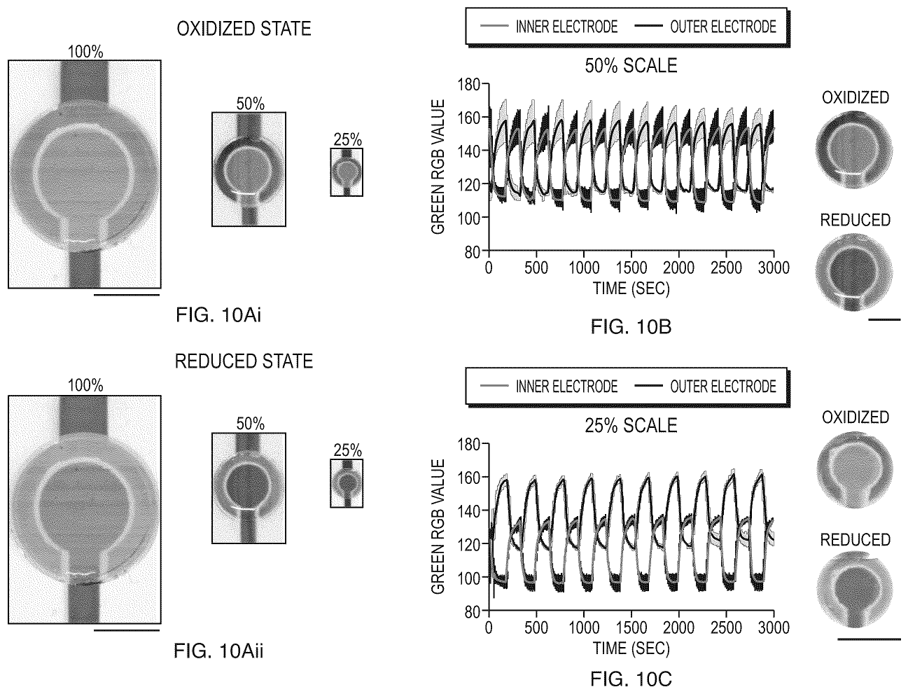

FIG. 10A is a picture illustrating a ECP printed at 100%, 50%, and 25% scale of the initial pixel size in the (i) oxidized and (ii) reduced states and demonstrates the scalability of the printed ECPs. While pixelation offers a mechanism to tune system resolution that can then be varied spatially depending on specific input signals, display resolution can be regulated directly by the numbers and sizes of each pixel. Thus, the concept of achieving high resolution, color-changing devices can be realized by increasing the density of individually addressable pixels within a unit device, which is investigated through scaling down the design of each ECP to understand its performance limitations. To start, the original pixels are scaled down by 2× and 4× the initial size, producing internal electrode diameters of 0.75 cm and 0.375 cm, respectively. The scale bars of the graphs correspond to 0.5 cm.

FIG. 10B is a graph illustrating green RGB value of a 50% scaled pixel and FIG. 10C is a graph illustrating green RGB value of a 25% scaled pixel. The +/−1.5 V input voltage is maintained, and observed color development is 30 seconds faster at 42% less current for the 50% (e.g., 2× scaled) size and is 40 seconds faster at 38% less current for the 25% (e.g., 4× scaled) size devices. FIGS. 21A-B are graphs illustrating green RGB values for the outside electrode and inner electrode for the 50% and 25% scale electrodes. Additionally, the color density was enriched with the ΔGreen values of 31.4±11.9 and 38.3±5.4 for the 50 and 25% size devices, respectively, as compared to ΔGreen values of 22.7±2.4 for the original device. These differences highlighted another important feature of the ECPs—their amenability to be scaled down and processed to produce higher resolution, programmable display elements.

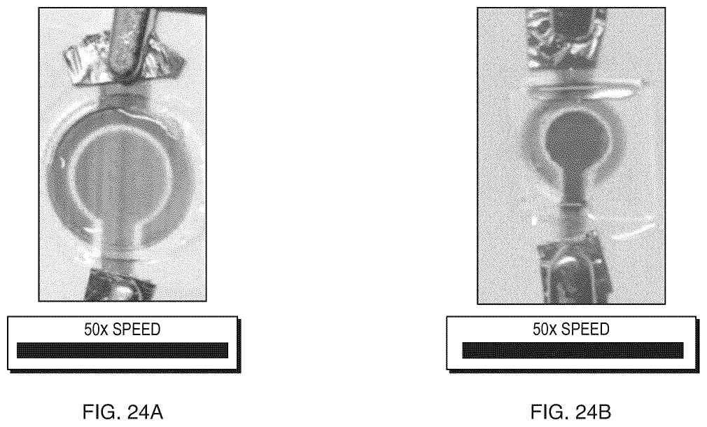

FIG. 24A is a photograph of a 10-layer 2 mg mL⁻¹ Xa 50% scale device color cycling at 50× speed with a scale bar corresponding to 1 cm.

FIG. 24B is a photograph of a 10-layer 2 mg mL⁻¹ Xa 25% scale device color cycling at 50× speed with a scale bar corresponding to 1 cm.

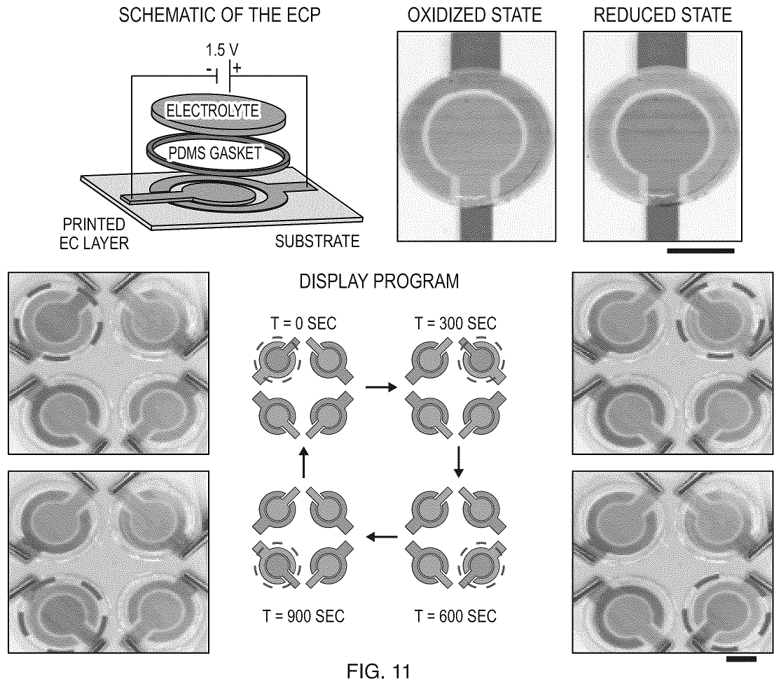

FIG. 11 is a schematic illustrating the electrochromic pixel (ECP) with a diagram of the cycle experiment. The schematic of the electrochromic pixel illustrates a printed EC layer on a substrate having an inner electrode and an outer electrode. A gasket, such as a PDMS gasket, is secured to the substrate around the outer electrode, and an electrically conductive electrolyte electrically couples the inner and outer electrode. The inner and outer electrode are physically separated by a gap, but are electrically coupled by the electrically conductive electrolyte. A positive voltage potential (1.5V) or negative voltage potential (−1.5V) can be applied to the leads of the respective electrodes and can result in an oxidized state or a reduced state. As a result, a display program can apply different voltage potentials to four electrochromic pixels at different times (e.g., t=0 sec, t=300 sec, t=600 sec, and t=900 sec). Upon the voltage being applied the electrochromic pixel changes state and therefore displayed color.

In the quest to develop accessible, adaptive optical technologies, new applications of bio-inspired materials and designs to create low energy ECPs are explored by the present disclosure. While printing electrochromic materials including metallo-supramolecular polymers, metal oxides, and conductive polymers has been done, the first application of Xa as an active component of electrochromic inks that can be printed as single, color-changing pixels is disclosed. While further development is necessary, the results demonstrate a promising first step towards producing scalable electrochromic patterns precisely and reproducibly in a process that offer sustainable low-power displays more mimetic of the natural systems they are designed to emulate.

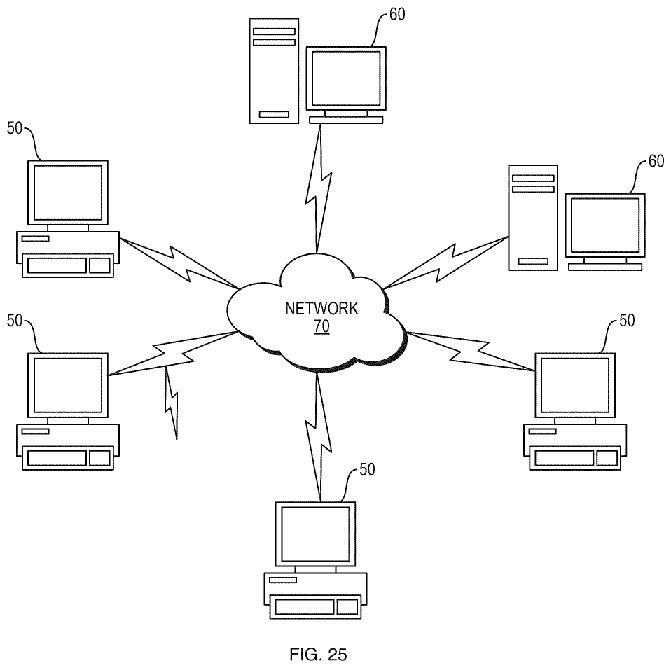

FIG. 25 illustrates a computer network or similar digital processing environment in which embodiments of the present invention may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

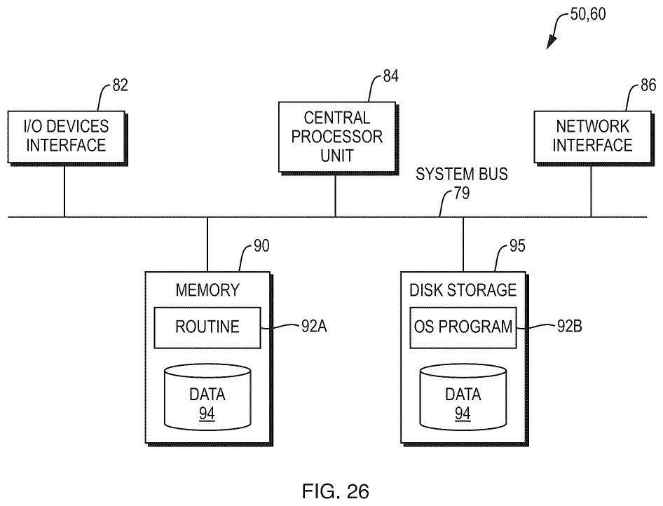

FIG. 26 is a diagram of an example internal structure of a computer (e.g., client processor/device 50 or server computers 60) in the computer system of FIG. 25. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 25). Memory 90 provides volatile storage for computer software instructions 92 and data 94 used to implement an embodiment of the present invention (e.g., signal generation code detailed above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. An electrochromic pixel, comprising:
a first electrode having a first electrical lead facilitating a power supply connection,
a second electrode having a second electrical lead facilitating the power supply connection,
an electrolyte electrically connecting the first and second electrodes, and
xanthommatin (Xa), or a derivative or precursor thereof, such that an electrical potential applied between the first electrode and the second electrode is configured to cause oxidation or reduction of the Xa, or a derivative or precursor thereof, thereby providing a change in reflected visible color of the Xa, or a derivative or precursor thereof.

2. The electrochromic pixel of claim 1, wherein the electrolyte is a liquid electrolyte.

3. The electrochromic pixels of claim 1, wherein one or more of the first electrode and second electrode are conductive electrodes made from indium-doped tin oxide (ITO) coated polyethylene terephthalate (PET) plastic.

4. The electrochromic pixel of claim 1, wherein the first electrode is a lower electrode, the second electrode is an upper electrode, and the electrochromic pixel further comprising:
a spacer configured to contain the electrolyte and provide a gap between the first electrode and second electrode.

5. The electrochromic pixel of claim 4, wherein the first electrode and second electrode are uncoated PET electrodes, the spacer is a non-conductive laser-cut PET spacer, the upper electrode is coated in poly(3,4-ethylenedioxthionphene) and polystyrene sulfonate (PETDOT:PSS).

6. The electrochromic pixel of claim 1, wherein the first electrode is an inner electrode connected to the first electrical lead, the second electrode is an outer electrode connected to a second electrical lead, wherein the outer electrode is separated from the inner electrode by a gap, the electrochromic pixel further comprising:
a gasket affixed to a substrate housing the inner electrode and the outer electrode and filled with the electrolyte.

7. The electrochromic pixel of claim 1, wherein the first electrode and the second electrode are coated with Xa, or a derivative or precursor thereof, and wherein applying the positive or negative electrical potential across the first electrical lead and second electrical lead of the first electrode and second electrode, respectively, is configured to cause the oxidation or reduction of Xa, or a derivative or precursor thereof, that provides the change in the reflected visible color in the Xa, or a derivative or precursor thereof.

8. The electrochromic pixel of claim 1, wherein the Xa, or a derivative or precursor thereof, is either Xa, dihydroxanthommatin, or a combination thereof.

9. A system comprising:
one or more reflectance-based color sensors oriented to sense color from outside of the system;
a display comprising one or more electrochromic pixels of claim 1;
a microcontroller and associated electronics operatively coupled to the one or more reflectance-based color sensors and the one or more electrochromic pixels, configured to receive information representing at least one of a color and light intensity detected by the one or more reflectance-based color sensors and determine a signal to send to the electrochromic pixels providing information to control at least one of color and light intensity, resulting in the electrochromic pixels presenting at least one of the color and light intensity.

10. The system of claim 9, further comprising:
one or more LEDs positioned to provide lighting for the one or more electrochromic pixels,
wherein the microcontroller and associated electronics are configured to:
determine the signal to send to the electrochromic pixels providing the information to control color, such that the signal controls a color of the electrochromic pixels, or
determine a second signal to send to the one or more LEDs providing information to control light intensity, such that the second signal controls light intensity of the one or more LEDs,
or both.

11. The system of claim 9, further comprising:
a battery operatively coupled to the microprocessor and associated electronics and one or more LEDs.

12. The system of claim 9, further comprising:
a housing, wherein:
the one or more reflectance-based color sensors, one or more electrochromic pixels, and microprocessor are within the housing, such that the one or more reflectance-based color sensors are on at least one face of the housing and oriented to sense color from outside of the housing, and the one or more electrochromic pixels are oriented to project the color outside of the housing.

13. The system of claim 9, wherein the Xa, or a derivative or precursor thereof, is either Xa, dihydroxanthommatin, or a combination thereof.

14. A display, comprising a plurality of the electrochromic pixels of claim 1.

15. The display of claim 14, wherein the Xa, or a derivative or precursor thereof, is either Xa, dihydroxanthommatin, or a combination thereof.

16. A method of providing an electrochromic pixel, comprising:
providing a power supply connection to a first electrode via a first electrical lead and to a second electrode via a second electrical lead;
electrically connecting the first and second electrodes via an electrolyte,
wherein xanthommatin (Xa), or a derivative or precursor thereof comprise at least part of the first electrode or second electrode or first and second electrodes, such that an electrical potential applied between the first electrode and the second electrode is configured to cause oxidation or reduction of the Xa, or a derivative or precursor thereof, thereby providing a change in reflected visible color of the Xa, or a derivative or precursor thereof.

17.-26. (canceled)

27. A method of manufacturing the electrochromic pixel of claim 1, the method comprising:
formulating an ink comprising dissolved xanthommatin (Xa), or a derivative or precursor thereof, and an electrically conductive ink; and
printing an electrochromic pixel pattern on at least one sheet of a substrate, the electrochromic pixel pattern including the first and second electrodes separated by a gap, the first electrode having a first electrical lead facilitating a power supply connection, and the second electrode having a second electrical lead facilitating the power supply connection.

28.-30. (canceled)

31. The method of claim 27, wherein the printing employs a piezoelectric inkjet printer.

32.-35. (canceled)

36. The method of claim 27, wherein the Xa, or a derivative or precursor thereof, is either Xa, dihydroxanthommatin, or a combination thereof.

37. An ink for an electrochromic pixel, the ink comprising:
xanthommatin (Xa), or a derivative or precursor thereof; and
an electrically conductive ink, wherein the Xa, or a derivative or precursor thereof, is in non-aggregated form.

38.-44. (canceled)
